(19) United States
(12) Patent Application Publication
(10) Pub. No.: US 2026/0298724 A1
(43) Pub. Date: Oct. 1, 2026

(54) TEMPERATURE ESTIMATION SYSTEM AND TEMPERATURE MEASUREMENT DEVICE

(71) Applicant: Asahi Kasei Microdevices Corporation, Tokyo (JP)

(72) Inventors: Masashi Higashino, Tokyo (JP); Yuta Takagi, Tokyo (JP); Ryuhei Shinozaki, Tokyo (JP)

(73) Assignee: Asahi Kasei Microdevices Corporation, Tokyo (JP)

(21) Appl. No.: 19/530,307

(22) Filed: Feb. 4, 2026

(30) Foreign Application Priority Data
Feb. 6, 2025 (JP) 2025-018377
Dec. 15, 2025 (JP) 2025-250898

(51) Int. Cl. G01K 1/024; G01J 5/12; G01K 7/18

(52) U.S. Cl. CPC G01K 1/024; G01J 5/12; G01K 7/18

(57) ABSTRACT

A temperature estimation system includes: an estimation unit, estimating a temperature of a measurement target by using a predetermined estimation model based on contactless and contact measurement data acquired by measuring the temperature of the measurement target; and a storage unit, storing measurement history data including the contactless and contact measurement data measured at multiple measurement opportunities. A temperature measurement device includes: a contactless type temperature measurement unit, measuring a temperature of a measurement target and acquiring contactless measurement data having multiple contactless measurement values; a contact type temperature measurement unit measuring the temperature of the measurement target and acquiring contact measurement data including multiple contact measurement values; and a transmission unit, transmitting measurement result information based on the contactless and contact measurement data.

### CROSS-REFERENCE TO RELATED APPLICATION

This application claims the priority benefit of Japanese application serial No. 2025-018377, filed on Feb. 6, 2025 and Japanese application serial No. 2025-250898, filed on Dec. 15, 2025. The entirety of each of the above-mentioned patent applications is hereby incorporated by reference herein and made a part of this specification.

### BACKGROUND

### Technical Field

The invention relates to a temperature estimation system, a temperature estimation method, a temperature measurement device, a temperature measurement method, and a program.

### Description of Related Art

Patent Document 1 describes “an electronic thermometer with a cover that includes a plurality of temperature measurement units including at least a contact type temperature measurement unit, and in the case of performing a body temperature measurement using only one of the temperature measurement units, can prevent occurrence of thermal disturbance without increasing burden on the user, and can always perform accurate body temperature measurement”.

### PRIOR ART DOCUMENT(S)

### Patent Document(s)

[Patent Document 1] Japanese Patent Application Laid-Open No. 2013-170935

### SUMMARY

An aspect of the invention provides a temperature estimation system. The temperature estimation system includes: an estimation unit, estimating a temperature of a measurement target by using a predetermined estimation model based on contactless measurement data and contact measurement data acquired by measuring the temperature of the measurement target; and a storage unit, storing measurement history data including the contactless measurement data and the contact measurement data measured at multiple measurement opportunities.

Another aspect of the invention provides a temperature measurement device. The temperature measurement device includes: a contactless type temperature measurement unit, measuring a temperature of a measurement target and acquiring contactless measurement data including multiple contactless measurement values; a contact type temperature measurement unit, measuring the temperature of the measurement target and acquiring contact measurement data including multiple contact measurement values; and a transmission unit, transmitting measurement result information based on the contactless measurement data and the contact measurement data.

The above summary of the invention does not enumerate all of the features of the invention. Also, sub-combinations of these feature groups can also become inventions.

### BRIEF DESCRIPTION OF THE DRAWINGS

FIG. 1 illustrates an example of the configuration of a temperature estimation system 500 together with a measurement target 10.

FIG. 2A illustrates an example of temporal changes of measurement data.

FIG. 2B illustrates an example of temporal changes of measurement data.

FIG. 3A illustrates an example of an estimation model 312.

FIG. 3B illustrates an example of the estimation model 312.

FIG. 4A illustrates an example of estimated temperature errors.

FIG. 4B illustrates an example of the variances of estimated values.

FIG. 5 illustrates a modified example of the configuration of the temperature estimation system 500 together with the measurement target 10.

FIG. 6 illustrates a modified example of the configuration of the temperature estimation system 500 together with the measurement target 10.

FIG. 7 illustrates an example of a temperature measurement method.

FIG. 8 illustrates an example of a temperature estimation method.

FIG. 9 illustrates an example of a temperature measurement device 100.

FIG. 10 illustrates an example of a semiconductor package 200.

FIG. 11A illustrates a modified example of the configuration of the temperature estimation system 500 together with the measurement target 10.

FIG. 11B illustrates a modified example of the temperature measurement device 100.

FIG. 12A illustrates a modified example of the configuration of the temperature estimation system 500 together with the measurement target 10.

FIG. 12B illustrates an example of the temperature measurement device 100.

FIG. 13 illustrates an example of temporal changes of measurement data.

FIG. 14A illustrates a modified example of the configuration of the temperature estimation system 500 together with the measurement target 10.

FIG. 14B illustrates a modified example of the temperature measurement device 100.

FIG. 15 illustrates a modified example of the configuration of the temperature estimation system 500 together with the measurement target 10.

FIG. 16 illustrates an example of a computer 1000 in which multiple aspects of the invention may be embodied in whole or in part.

### DESCRIPTION OF THE EMBODIMENTS

In a first aspect of the invention, a temperature estimation system is provided. T temperature estimation system includes: includes: an estimation unit, estimating a temperature of a measurement target by using a predetermined estimation model based on contactless measurement data and contact measurement data acquired by measuring the temperature of the measurement target; and a storage unit, storing measurement history data including the contactless measurement data and the contact measurement data measured at multiple measurement opportunities.

It may also be that, the temperature estimation system includes: a model update unit, updating the estimation model based on the measurement history data.

In the temperature estimation system according any of the above, it may also be that, by using the updated estimation model, the estimation unit corrects the temperature of the measurement target estimated based on the contactless measurement data and the contact measurement data measured at past measurement opportunities of the measurement opportunities.

The temperature estimation system according any of the above includes: a measurement related information acquisition unit, acquiring measurement related information relating to the measurement target and a situation of measuring the temperature of the measurement target.

In the temperature estimation system according any of the above, it may also be that, the estimation model includes multiple estimation models

In the temperature estimation system according any of the above, it may also be that, the estimation unit selects an estimation model for estimating the temperature of the measurement target from the estimation models in response to the measurement related information.

In the temperature estimation system according any of the above, it may also be that, the contact measurement data includes multiple contact measurement values.

In the temperature estimation system according any of the above, it may also be that, the temperature estimation system includes: a notification unit, notifying that a quantity of the contact measurement values acquired from or after a rise time point of the contact measurement data has exceeded a predetermined reference value.

In the temperature estimation system according any of the above, it may also be that, the contact measurement data includes multiple contact measurement values.

In the temperature estimation system according any of the above, it may also be that, the contactless measurement data includes multiple contactless measurement value.,

In the temperature estimation system according any of the above, it may also be that, the estimation unit inputs at least one of the contactless measurement values and two or more contact measurement values among the contact measurement values into the estimation model to estimate the temperature of the measurement target.

In the temperature estimation system according any of the above, it may also be that, the estimation unit inputs an estimated parameter calculated based on the contactless measurement data and the contact measurement data to the estimation model to estimate the temperature of the measurement target.

In the temperature estimation system according any of the above, it may also be that, the estimation model is a model generated based on a statistical estimation method.

In the temperature estimation system according any of the above, it may also be that, the statistical estimation method is Bayesian estimation.

In the temperature estimation system according any of the above, it may also be that, the estimation model has a posterior probability distribution generated in advance based on the Bayesian estimation.

In the temperature estimation system according any of the above, it may also be that, the posterior probability distribution is generated by using multiple contactless measurement values and multiple contact measurement values.

In the temperature estimation system according any of the above, it may also be that, an estimated value having a highest probability in the posterior probability distribution is set as an estimated value of the temperature of the measurement target.

The temperature estimation system according any of the above may include: a display unit, displaying the temperature of the measurement target estimated by the estimation unit.

In the temperature estimation system according any of the above, it may also be that, the display unit displays a transition of the temperature of the measurement target estimated by the estimation unit.

In the temperature estimation system according any of the above, it may also be that, the estimation unit determines whether the temperature of the measurement target is able to be estimated based on the contactless measurement data and the contact measurement data.

In the temperature estimation system according any of the above, it may also be that, the display unit displays a measurement error in a case where the estimation unit determines that the temperature of the measurement target is unable to be estimated.

According to a second aspect of the invention, a temperature estimation system is provided. The temperature estimation system includes: a contactless type temperature measurement unit, measuring a temperature of a measurement target and acquiring contactless measurement data including multiple contactless measurement values; a contact type temperature measurement unit, measuring the temperature of the measurement target and acquiring contact measurement data including multiple contact measurement values; an estimation unit, estimating the temperature of the measurement target by using a predetermined estimation model based on the contactless measurement data and the contact measurement data.

The temperature estimation system may include: a measurement related information acquisition unit, acquiring measurement related information relating to the measurement target and a situation of measuring the temperature of the measurement target.

In the temperature estimation system according any of the above, it may also be that, the estimation model includes multiple estimation models, and the estimation unit selects an estimation model for estimating the temperature of the measurement target from the estimation models in response to the measurement related information.

The temperature estimation system according any of the above may include: a storage unit, storing measurement history data including the contactless measurement data and the contact measurement data measured at multiple measurement opportunities.

The temperature estimation system according any of the above may include: a model update unit, updating the estimation model based on the measurement history data.

In the temperature estimation system according any of the above, it may also be that, by using the updated estimation model, the estimation unit updates the temperature of the measurement target estimated at past measurement opportunities of the measurement opportunities based on the contactless measurement data and the contact measurement data measured at the past measurement opportunities.

The temperature estimation system according any of the above may include: a notification unit, notifying that a quantity of the contact measurement values acquired from or after a rise time point of the contact measurement data has exceeded a predetermined reference value.

In the temperature estimation system according any of the above, it may also be that, the estimation unit inputs at least one of the contactless measurement values and two or more contact measurement values among the contact measurement values into the estimation model to estimate the temperature of the measurement target.

In the temperature estimation system according any of the above, it may also be that, the estimation unit inputs an estimated parameter calculated based on the contactless measurement data and the contact measurement data to the estimation model to estimate the temperature of the measurement target.

In the temperature estimation system according any of the above, it may also be that, the estimation model is a model generated based on a statistical estimation method.

The temperature estimation system according any of the above may include: a display unit, displaying the temperature of the measurement target estimated by the estimation unit.

In the temperature estimation system according any of the above, it may also be that, the display unit displays a transition of the temperature of the measurement target estimated by the estimation unit.

In the temperature estimation system according any of the above, it may also be that, the estimation unit determines whether the temperature of the measurement target is able to be estimated based on the contactless measurement data acquired by the contactless type temperature measurement unit and the contact measurement data acquired by the contact type temperature measurement unit. It may also be that the display unit displays a measurement error in a case where the estimation unit determines that the temperature of the measurement target is unable to be estimated.

A third aspect of the invention provides a temperature estimation method. The temperature estimation method includes: a step of acquiring contactless measurement data including multiple contactless measurement values acquired by measuring a temperature of a measurement target by using a contactless type temperature measurement unit of a temperature measurement device; a step of acquiring contact measurement data including multiple contact measurement values acquired by measuring the temperature of the measurement target by using a contact type temperature measurement unit of the temperature measurement device; and a step of estimating the temperature of the measurement target based on the contactless measurement data and the contact measurement data by using a predetermined estimation model.

A program according to a fourth aspect of the invention is provided. When executed by a computer, the program causes a computer to: acquire contactless measurement data including multiple contactless measurement values acquired by measuring a temperature of a measurement target by using a contactless type temperature measurement unit of a temperature measurement device; acquire contact measurement data including multiple contact measurement values acquired by measuring the temperature of the measurement target by using a contact type temperature measurement unit of the temperature measurement device; and estimate the temperature of the measurement target based on the contactless measurement data and the contact measurement data by using a predetermined estimation model.

A fifth aspect of the invention provides a temperature measurement device. The temperature measurement device includes: a contactless type temperature measurement unit that measures a temperature of a measurement target and acquires contactless measurement data including multiple contactless measurement values; a contact type temperature measurement unit, measuring the temperature of the measurement target and acquiring contact measurement data including multiple contact measurement values; and a transmission unit, transmitting measurement result information based on the contactless measurement data and the contact measurement data.

In the temperature measurement device according to any of the above, it may also be that, the transmission unit may transmit, as the measurement result information, at least one of the contactless measurement values and two or more contact measurement values among the contact measurement values.

In the temperature measurement device according to any of the above, it may also be that, the transmission unit transmits an estimated parameter calculated based on the contactless measurement data and the contact measurement data as the measurement result information.

The temperature measurement device according to any of the above may include: measurement related information acquisition unit that acquires measurement related information relating to the measurement target and a situation of measuring the temperature of the measurement target.

In the temperature measurement device according to any of the above, it may also be that, the transmission unit transmits the measurement result information and the measurement related information.

A sixth aspect of the invention provides a temperature measurement method. The temperature measurement method includes: a step in which a contactless type temperature measurement unit of a temperature measurement device measures a temperature of a measurement target to acquire contactless measurement data including multiple contactless measurement values; a step in which a contact type temperature measurement unit of the temperature measurement device measures the temperature of the measurement target to acquire contact measurement data including multiple contact measurement values; and a stage in which measurement result information is transmitted based on the contactless measurement data and the contact measurement data.

A seventh aspect of the invention provides a program. When executed by a computer, the program causes the computer to: control a contactless type temperature measurement unit of a temperature measurement device to measure a temperature of a measurement target and acquire contactless measurement data including multiple contactless measurement values; control a contact type temperature measurement unit of the temperature measurement device to measure the temperature of the measurement target and acquire contact measurement data including multiple contact measurement values; and transmit measurement result information based on the contactless measurement data and the contact measurement data.

Hereinafter, the invention will be described through embodiments of the invention, but the following embodiments do not limit the invention according to the claims. Also, not all combinations of features described in the embodiments are necessarily essential to the solution of the invention.

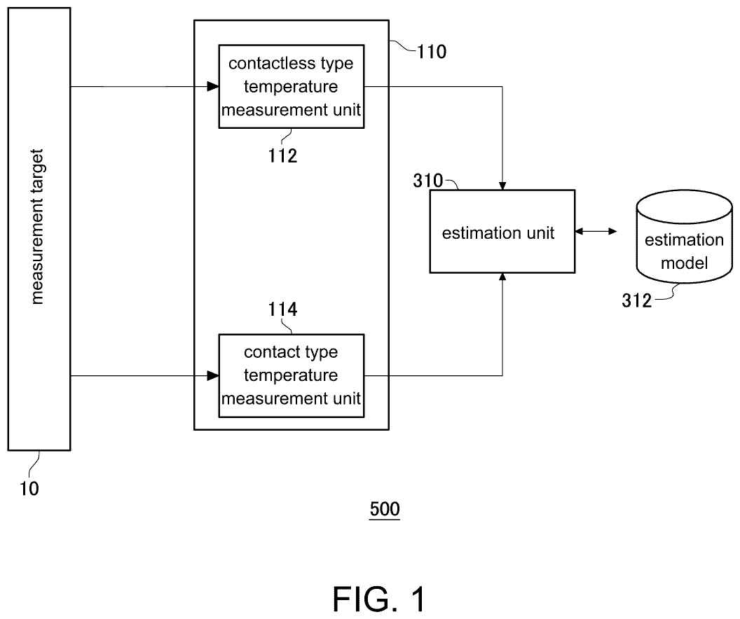

FIG. 1 illustrates an example of the configuration of a temperature estimation system 500 together with a measurement target 10. The temperature estimation system 500 includes a temperature measurement module 110 and an estimation unit 310. The temperature measurement module 110 has a contactless type temperature measurement unit 112 and a contact type temperature measurement unit 114. The illustrated blocks are functional blocks that are functionally separated respectively, and do not necessarily have to correspond to the actual device configuration. That is, a block shown as one block in the figure does not necessarily have to be configured by one device. Also, blocks illustrated as separate blocks in the figure do not necessarily have to be configured by separate devices. The same applies to blocks in other figures.

The temperature estimation system 500 estimates the temperature of the measurement target 10. The measurement target 10 may be a living organism. The measurement target 10 may be a human body, and may also be an animal. For example, in the case where the temperature of the measurement target 10 is higher than the environmental temperature, the temperature estimation system 500 can estimate the temperature of the measurement target 10. As an example, the temperature estimation system 500 estimates the temperature of a human body.

The contactless type temperature measurement unit 112 measures the temperature of the measurement target 10 and acquires contactless measurement data including multiple contactless measurement values. The contactless type temperature measurement unit 112 may be able to measure the temperature of the measurement target 10 in a state of not contacting the measurement target 10. For example, the contactless type temperature measurement unit 112 has a radiation thermometer that measures a temperature based on the radiation from the measurement target 10. As an example, the contactless type temperature measurement unit 112 has a quantum type infrared sensor. As another example, the contactless type temperature measurement unit 112 has a thermopile type infrared sensor.

The contactless measurement data acquired by the contactless type temperature measurement unit 112 is not limited to the measurement data acquired in a state where the contactless type temperature measurement unit 112 does not contact the measurement target 10. The contactless measurement data may include the measurement data acquired in a state where the contactless type temperature measurement unit 112 contacts the measurement target 10. For example, in the case where the contactless type temperature measurement unit 112 has a radiation thermometer, the contactless type temperature measurement unit 112 is able to measure the temperature based on the radiation from the measurement target 10 even in a state of contacting the measurement target 10.

The contact type temperature measurement unit 114 measures the temperature of the measurement target 10 and acquires the contact measurement data including multiple contact measurement values. The contact type temperature measurement unit 114 may be able to measure the temperature of the measurement target 10 in a state of being in contact with the measurement target 10. For example, the contact type temperature measurement unit 114 may have a thermal resistance thermometer that measures a temperature based on an electrical resistance change due to a temperature change, and may have a thermoelectromotive force thermometer that measures the temperature based on the thermoelectromotive force due to a temperature difference. As an example, the contact type temperature measurement unit 114 has a platinum resistor, a thermocouple, or a thermistor.

The estimation unit 310 estimates the temperature of the measurement target 10 based on the contactless measurement data and the contact measurement data by using a predetermined estimation model 312. Details of the temperature estimation method by the estimation unit 310 and the estimation model 312 will be described later.

In addition, in the example, the temperature estimation system 500 has been described as including the temperature measurement module 110, but the temperature estimation system 500 does not need to include the temperature measurement module 110. In this case, the temperature estimation system 500 may also acquire the contactless measurement data and the contact measurement data via communication with an external temperature measurement module 110. As another example, the temperature estimation system 500 may acquire the contactless measurement data and the contact measurement data stored in the server via communication with a server that stores the contactless measurement data and the contact measurement data measured by the external temperature measurement module 110. In the case where the temperature estimation system 500 does not include the temperature measurement module 110, the means for acquiring the contactless measurement data and the contact measurement data is arbitrary. The same applies to other figures.

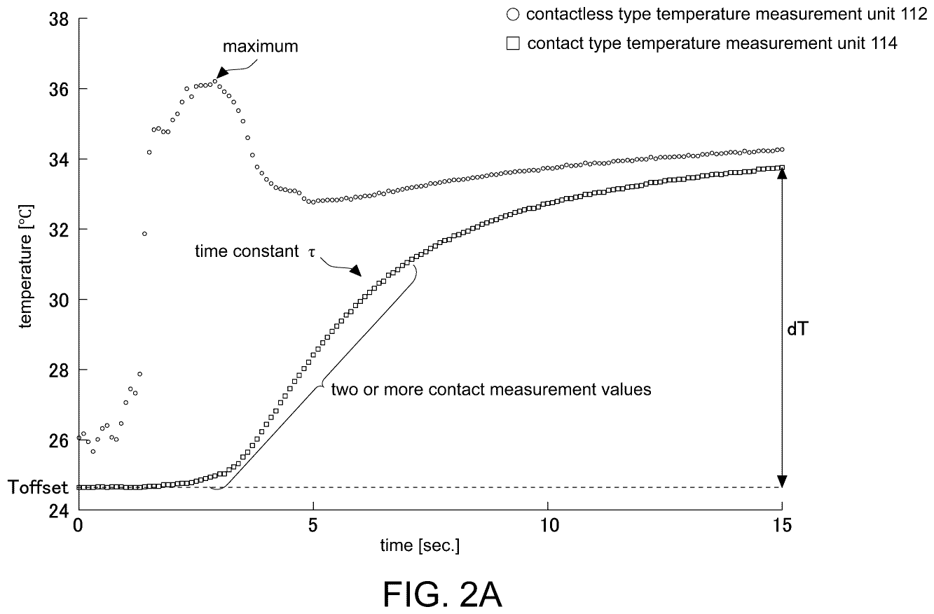

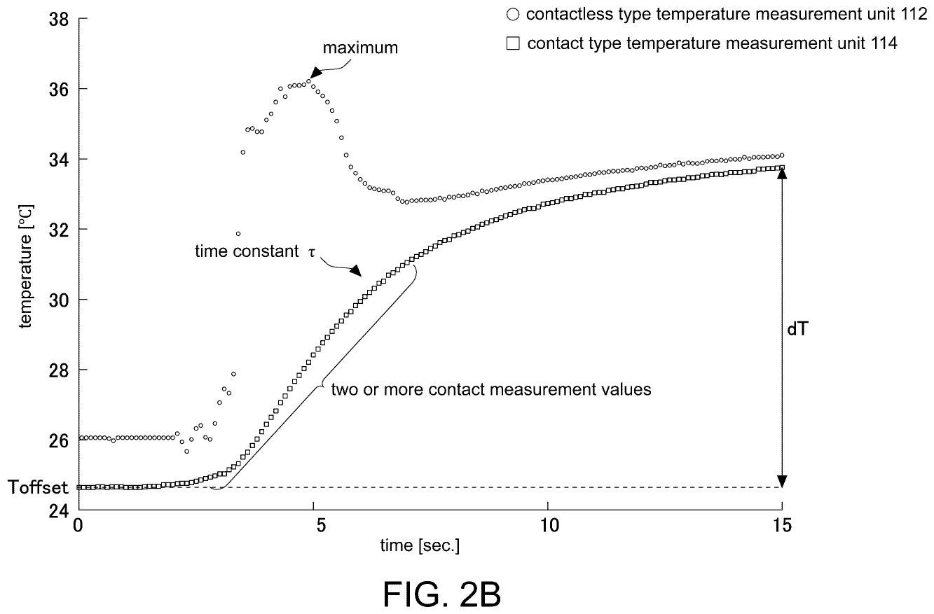

FIG. 2A illustrates an example of temporal changes of measurement data. In this figure, the horizontal axis represents time, and the vertical axis represents temperature acquired as measurement data. White circles represent temperatures acquired by the contactless type temperature measurement unit 112 as contactless measurement data, and white squares represent temperatures acquired by the contact type temperature measurement unit 114 as contact measurement data. Each of the white circles is a contactless measurement value, and each of the white squares is a contact measurement value. That is, each measurement value acquired by the contactless type temperature measurement unit 112 is referred to as a contactless measurement value, and a set of contactless measurement values acquired by the contactless type temperature measurement unit 112 over time is referred to as contactless measurement data. The same applies to contact measurement values and contact measurement data.

The contactless type temperature measurement unit 112 may acquire the contactless measurement data at a time interval of 0.004 seconds or more and 5 seconds or less. That is, the time interval between contactless measurement values may be 0.004 seconds or more and 5 seconds or less. For example, in the case where the time interval is 0.004 seconds, the power consumption for driving the contactless type temperature measurement unit 112 increases, but the temporal change of the contactless measurement data can be accurately detected. In the case where the time interval is 5 seconds, the power consumption for driving the contactless type temperature measurement unit 112 can be reduced. The contactless type temperature measurement unit 112 may acquire the contactless measurement data at a time interval of 0.1 seconds or more and 0.5 seconds or less. In this way, the measurement accuracy can be improved while the power consumption for driving the contactless type temperature measurement unit 112 is reduced. The contactless type temperature measurement unit 112 of the example acquires contactless measurement data at a time interval of 0.1 seconds.

For example, in the case where the contactless type temperature measurement unit 112 has a radiation thermometer that measures the temperature based on the radiation from the measurement target 10, the contactless type temperature measurement unit 112 measures the temperature based on the radiation within the field of view of the contactless type temperature measurement unit 112. In the case where radiation from radiation sources other than the measurement target 10 is included within the field of view of the contactless type temperature measurement unit 112, the measured temperature may include the influence of the temperature of such radiation sources. Therefore, with the field of view of the contactless type temperature measurement unit 112 being covered with the measurement target 10, a more accurate measurement becomes possible.

When the contactless type temperature measurement unit 112 or the temperature measurement device having the contactless type temperature measurement unit 112 contacts the measurement target 10, the contactless measurement data decreases. For example, in the case where the contactless type temperature measurement unit 112 has a radiation thermometer that measures the temperature based on the radiation from the measurement target 10, the radiation sensor that detects radiation from the measurement target 10 outputs a current corresponding to the difference between the temperature of the measurement target 10 and the temperature of the radiation sensor. The radiation thermometer calculates the temperature based on the magnitude of the current output by the radiation sensor and the temperature of the built-in thermometer. When the contactless type temperature measurement unit 112 or the temperature measurement device having the contactless type temperature measurement unit 112 contacts the measurement target 10, the temperature of the radiation sensor close to the surface of the temperature measurement device may become higher than the temperature of the built-in thermometer first. In this case, the amount of the current output by the radiation sensor becomes small. However, the built-in thermometer is lower than the temperature of the radiation sensor, so, as a result, the radiation thermometer may output a temperature lower than the actual temperature.

Based on the above operation, the time point at which the contactless measurement data decreases has a high probability of being the time point at which the contactless type temperature measurement unit 112 or the temperature measurement device having the contactless type temperature measurement unit 112 contacts the measurement target 10. In other words, in the vicinity of the time point at which the contactless measurement data decreases, there is a high probability that the field of view of the contactless type temperature measurement unit 112 is covered by the measurement target 10. Therefore, the contactless measurement data in the vicinity of the time point at which the contactless measurement data decreases has a high probability of accurately reflecting the temperature of the measurement target 10.

The contact type temperature measurement unit 114 may acquire the contact measurement data at a time interval of 0.004 seconds or more and 5 seconds or less. That is, the time interval between contact measurement values may be 0.004 seconds or more and 5 seconds or less. The contact type temperature measurement unit 114 of the example acquires contact measurement data at a time interval of 0.1 seconds.

For example, in the case where the contact type temperature measurement unit 114 has a thermal resistance thermometer that measures a temperature based on an electrical resistance change due to temperature change or a thermoelectromotive force thermometer that measures a temperature based on a thermoelectromotive force due to a temperature difference, the contact measurement data depends on the temperature change of the contact type temperature measurement unit 114. The temperature change of the contact type temperature measurement unit 114 follows Newton's cooling law and is represented by, for example, the following formula.

$$T = dT [ 1 - exp ( - t / τ ) ] + Toffset$$

Here, T is the temperature of the contact type temperature measurement unit 114, Toffset is the temperature before the contact type temperature measurement unit 114 contacts the measurement target 10, dT is the difference between the temperature of the measurement target 10 and Toffset, and τ is the time constant. The time constant τ is a constant defined by the heat transfer coefficient between the measurement target 10 and the contact type temperature measurement unit 114, the surface area where the contact type temperature measurement unit 114 contacts the measurement target 10, and the heat capacity of the contact type temperature measurement unit 114, etc. The contact type temperature measurement unit 114 may acquire the contact measurement data based on the temperature change according to the above formula.

The estimation unit 310 may input at least one of the contactless measurement values and two or more contact measurement values among the contact measurement values to the estimation model 312 to estimate the temperature of the measurement target 10. The at least one of the contactless measurement values may include a contactless measurement value representing a maximum of the contactless measurement data. The two or more contact measurement values among the contact measurement values may be two or more contact measurement values acquired from or after the rise time point of the contact measurement data. Details of the estimation model 312 will be described later.

As described above, the contactless measurement value representing the maximum of the contactless measurement data has a high probability of accurately reflecting the temperature of the measurement target 10. By estimating the temperature of the measurement target 10 based on the contactless measurement value representing the maximum of the contactless measurement data, the temperature of the measurement target 10 can be accurately estimated. However, the contactless measurement value used for estimating the temperature of the measurement target 10 is not limited to the contactless measurement value representing the maximum of the contactless measurement data. The estimation unit 310 may also estimate the temperature of the measurement target 10 based on other contactless measurement values. The contactless measurement value used by the estimation unit 310 for estimating the temperature of the measurement target 10 may be contactless measurement values before, at, and after the contactless measurement value representing the maximum of the contactless measurement data. For example, the estimation unit 310 may estimate the temperature of the measurement target 10 based on the contactless measurement value representing 90% of the maximum of the contactless measurement data.

As described above, two or more contact measurement values acquired from or after the rise time point of the contact measurement data reflect the temperature change of the contact type temperature measurement unit 114. The temperature change of the contact type temperature measurement unit 114 includes the influence of the difference between the temperature of the measurement target 10 and Toffset, that is, includes the influence of the temperature of the measurement target 10. Therefore, by estimating the temperature of the measurement target 10 based on two or more contact measurement values acquired from or after the rise time point of the contact measurement data, the temperature of the measurement target 10 can be accurately estimated.

The number of contact measurement values used for estimation of the temperature of the measurement target 10 may be two. By using at least two contact measurement values, the time constant τ and the temperature Toffset can be calculated. The influence of the temperature difference dT can be estimated from the calculated time constant τ and the temperature Toffset, that is, the temperature of the measurement target 10 can be estimated. However, the number of contact measurement values used for estimation of the temperature of the measurement target 10 is not limited to two. The number of contact measurement values used for estimation of the temperature of the measurement target 10 may also be three or more. By using three or more contact measurement values, the time constant τ and the temperature Toffset can be calculated more accurately, and the temperature of the measurement target 10 can be estimated more accurately.

The contact measurement value used for estimation of the temperature of the measurement target 10 may be a contact measurement value acquired within a period of 20 seconds or less from the rise time point of the contact measurement data. As an example, the contact measurement value used for estimation of the temperature of the measurement target 10 is a contact measurement value acquired within 10 seconds from the rise time point of the contact measurement data.

The contact measurement value used for estimation of the temperature of the measurement target 10 may be a contact measurement value acquired from the rise time point of the contact measurement data to the time point when the contact measurement data becomes at least 70% of the temperature difference dT. When the contact measurement data becomes larger than 70% of the temperature difference dT, the influence by the exponential function term becomes small, and the temperature change of the contact type temperature measurement unit 114 becomes relatively small. Therefore, by using the contact measurement value acquired by the time point until the contact measurement data becomes 70% of the temperature difference dT, the time constant τ and the temperature Toffset can be calculated with sufficient accuracy, and the temperature of the measurement target 10 can be estimated with sufficient accuracy. However, the estimation unit 310 may also estimate the temperature of the measurement target 10 based on the contact measurement value after the time point when the contact measurement data becomes 70% of the temperature difference dT.

In the above description, the estimation unit 310 is described as a component for inputting at least one of the contactless measurement values and two or more contact measurement values among the contact measurement values to the estimation model 312, but the data that the estimation unit 310 inputs to the estimation model 312 is not limited to this. The estimation unit 310 may also input estimated parameters calculated based on the contactless measurement data and the contact measurement data to the estimation model 312 to estimate the temperature of the measurement target 10. For example, the estimated parameters include the temperature Toffset and the time constant τ. That is, the temperature Toffset and the time constant τ may be calculated in the estimation model 312, or the temperature Toffset and the time constant τ calculated in advance may be input to the estimation model 312. Details of the estimation model 312 will be described later.

As described above, the estimation unit 310 of this example estimates the temperature of the measurement target 10 based on the behavior in which the contactless measurement data has a peak and the behavior in which the contact measurement data has a rise. The contactless type temperature measurement unit 112 and the contact type temperature measurement unit 114 may also measure the temperature of the measurement target 10 in a process of transitioning from a state in which the temperature measurement device having the contactless type temperature measurement unit 112 and the contact type temperature measurement unit 114 does not contact the measurement target 10 to a state in which the temperature measurement device contacts the measurement target 10.

FIG. 2B illustrates an example of temporal changes of measurement data. The figure differs from the example of FIG. 2A in that a deviation occurs between the rise time point of the contact measurement data and the time point when the contactless measurement data decreases. For example, in the case where the temperature measurement device having the contactless type temperature measurement unit 112 and the contact type temperature measurement unit 114 is brought into contact with the measurement target 10, when heat conduction occurs to the contact type temperature measurement unit 114 prior to the contactless type temperature measurement unit 112, a timing deviation as shown in FIG. 2B may occur. Alternatively, the timing deviation as shown in FIG. 2B may occur due to a deviation or the like of the temperature measurement device while the temperature measurement device having the contactless type temperature measurement unit 112 and the contact type temperature measurement unit 114 is being brought into contact with the measurement target 10.

Even in this case, the estimation unit 310 may input at least one of the contactless measurement values and two or more contact measurement values among the contact measurement values to the estimation model 312 to estimate the temperature of the measurement target 10, and may input the estimated parameters calculated based on the contactless measurement data and the contact measurement data to the estimation model 312 to estimate the temperature of the measurement target 10. The at least one of the contactless measurement values may include a contactless measurement value representing a maximum of the contactless measurement data. The two or more contact measurement values among the contact measurement values may be two or more contact measurement values acquired from or after the rise time point of the contact measurement data. The estimated parameters may include the temperature Toffset and the time constant τ. That the temperature of the measurement target 10 can be accurately estimated based on the contactless measurement values and contact measurement values is as described with reference to FIG. 2A.

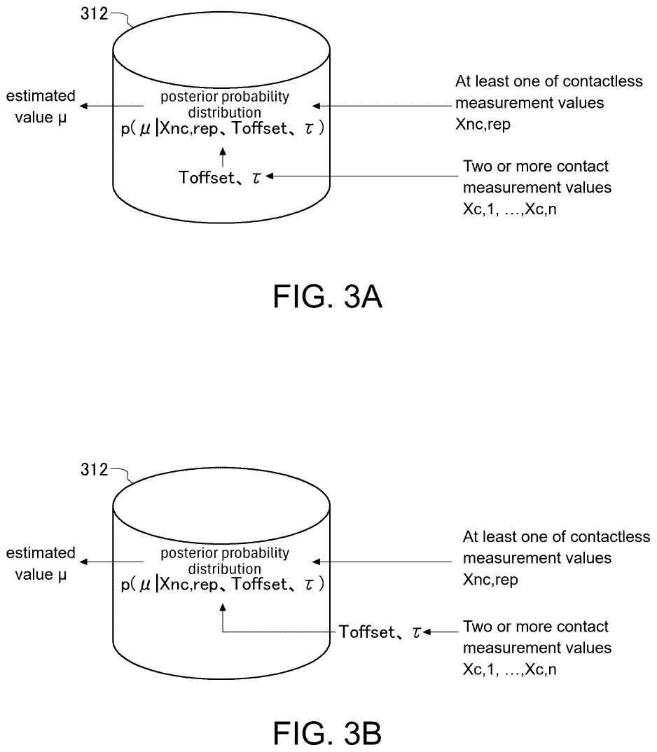

FIG. 3A illustrates an example of the estimation model 312. The estimation model 312 of the example is a model that receives the input of at least one Xnc,rep of multiple contactless measurement values and two or more contact measurement values Xc,1, . . . Xc, n, and outputs an estimated value μ of the temperature of the measurement target 10.

The estimation model 312 may be a model generated based on a statistical estimation method. For example, the estimation model 312 is a model generated based on Bayesian estimation. However, the statistical estimation method used for generating the estimation model 312 is not limited to Bayesian estimation.

The estimation model 312 may have a posterior probability distribution p(μ|Xnc,rep, Toffset, τ) generated in advance based on Bayesian estimation. The posterior probability distribution p(μ|Xnc,rep, Toffset, τ) is a conditional probability distribution representing a distribution of an estimated value μof the temperature of the measurement target 10 in the case where at least one Xnc, rep of the contactless measurement values, the temperature Toffset, and the time constant τ are given. The estimation model 312 may calculate the temperature Toffset and the time constant τ from two or more contact measurement values Xc,1, . . . Xc, n, and may derive the posterior probability distribution p(μ|Xnc,rep, Toffset, τ) from the calculated temperature Toffset and time constant τ and the at least one Xnc,rep of the contactless measurement values. The estimation model 312 may output a value of the estimated value μhaving the highest probability in the derived posterior probability distribution p(μ|Xnc,rep, Toffset, τ) as the estimated value μof the temperature of the measurement target 10.

The posterior probability distribution p(μ|Xnc,rep, Toffset, τ) may be generated in advance at the generation stage of the estimation model 312. The posterior probability distribution p(μ|Xnc,rep, Toffset, τ) may be generated by using data acquired by measuring the temperature of the measurement target 10 with a highly accurate method, the at least one Xnc, rep of the contactless measurement values when the temperature of the measurement target 10 is the measured temperature, and the two or more contact measurement values Xc,1, . . . Xc,n. For example, the data acquired by measuring the temperature of the measurement target 10 with a highly accurate method is the data acquired in the case where the contact type temperature measurement unit 114 and the measurement target 10 are brought into contact for a sufficiently long period of time to an extent that the contact type temperature measurement unit 114 and the measurement target 10 can be considered to have reached thermal equilibrium. However, the highly accurate method for measuring the temperature of the measurement target 10 is not limited thereto.

More specifically, the posterior probability distribution p(μ|Xnc,rep, Toffset, τ) may be generated from the likelihood function p(Xnc,rep|μ), the prior probability distribution p(μ), and the prior probability distribution p(Toffset, τ). The likelihood function p(Xnc,rep|μ) is a conditional probability distribution of the at least one Xnc,rep of the contactless measurement values in the case where the temperature of the measurement target 10 is a temperature measured with a highly accurate method. The prior probability distribution p(Toffset, τ) is a probability distribution of the temperature Toffset and the time constant τ in the case where the temperature of the measurement target 10 is a temperature measured by a highly accurate method. The prior probability distribution p(μ) may be an appropriately set probability distribution of the temperature of the measurement target 10, and is, for example, a uniform distribution.

The estimation model 312 of the example is generated based on a statistical estimation method using data acquired by measuring the temperature of the measurement target 10 with a highly accurate method. In this way, by using the measurement data acquired in a relatively short period of time of the at least one of the contactless measurement values Xnc, rep and the two or more contact measurement values Xc,1, . . . Xc, n, the temperature of the measurement target 10 can be accurately estimated.

The likelihood function used for generating the posterior probability distribution p(μ|Xnc,rep, Toffset, τ) is not limited to the example described above. The posterior probability distribution p(μ|Xnc,rep, Toffset, τ) may be generated in consideration of other influences related to estimation, such as measurement errors of the contactless type temperature measurement unit 112, variance, variation for each measurement device, variation for each measurement target 10, and measurement errors and variance of the contact type temperature measurement unit 114.

As described above, the temperature estimation system 500 of the example estimates the temperature of the measurement target 10 based on the contactless measurement data and the contact measurement data. Accordingly, the temperature of the measurement target 10 can be accurately estimated.

In the case of estimating the temperature of the measurement target 10 based on the contact measurement data only, the time until the heat transfer between the contact type temperature measurement unit and the measurement target 10 progresses sufficiently may be required, and the time until the estimation of the temperature of the measurement target 10 may be required. The temperature estimation system 500 of the example estimates the temperature of the measurement target 10 based on the contactless measurement data and the contact measurement data by using the predetermined estimation model 312. Therefore, the temperature of the measurement target 10 can be calculated accurately in a shorter period of time than the case of estimating the temperature of the measurement target 10 based on the contact measurement data only. That is, in the temperature estimation system 500 of the example, since the predetermined estimation model 312 is used, it is not necessary to wait until the heat transfer progresses sufficiently.

FIG. 3B illustrates an example of the estimation model 312. The estimation model 312 of the example differs from the embodiment of FIG. 3A in that it receives the input of at least one Xnc, rep of the contactless measurement values, the temperature Toffset, and the time constant τ, and outputs the estimated value μ of the temperature of the measurement target 10. Others may be the same as the embodiment of FIG. 3A.

In the above description, the estimation model 312 is described as a model generated based on a statistical estimation method, but the estimation model 312 is not limited thereto. As an example, the estimation model 312 may be a model generated by machine learning.

For example, the estimation model 312 is a trained model for causing a computer to function to output the temperature of the measurement target 10 based on the contactless measurement data and the contact measurement data. The parameters of the estimation model 312 may be trained by using the contactless measurement data, the contact measurement data, and the temperature of the measurement target 10 when the contactless measurement data and the contact measurement data are measured. The estimation model 312 may cause the computer to function to receive the contactless measurement data and the contact measurement data as input, perform an arithmetic operation based on the parameters on the input data, and output the temperature of the measurement target 10.

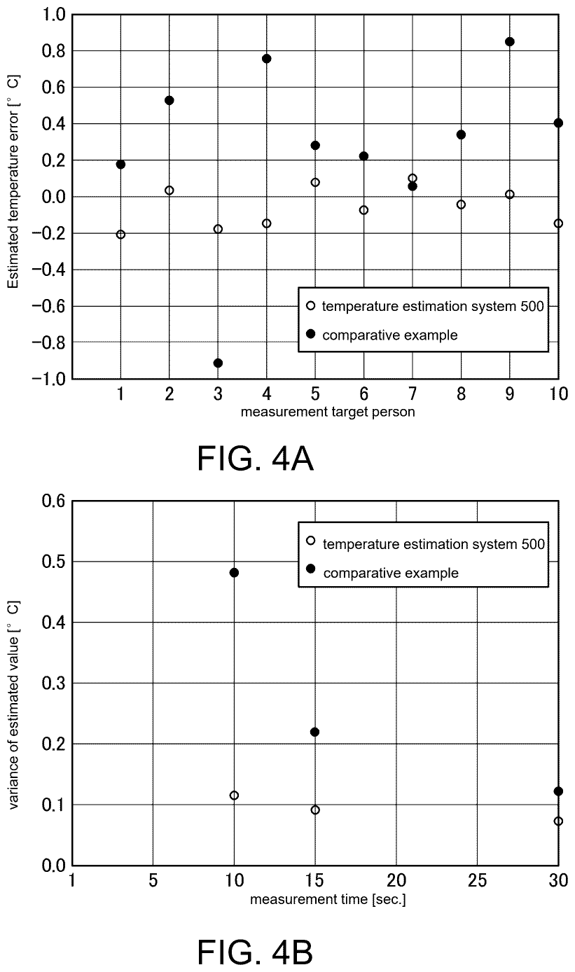

FIG. 4A illustrates an example of estimated temperature errors. The figure illustrates the error from the actual temperature when the temperature is estimated by using measurement data of 10 seconds for 10 measurement target persons. The white circles are the estimated temperature errors when estimated by using the temperature estimation system 500 of the example, and the black circles indicate the estimated temperature errors according to the comparative example. In the comparative example, the temperature is estimated based only on the contact measurement data.

As indicated in FIG. 4A, in the case where the temperature estimation system 500 of the example is used, the estimated temperature error is at most about 0.2° C. On the other hand, when the comparative example is used, the estimated temperature error is at most about 0.9° C. In this way, the temperature estimation system 500 of this example can more accurately estimate the temperature of the measurement target 10 than the case where the temperature of the measurement target 10 is estimated based on only the contact measurement data.

FIG. 4B illustrates an example of variances of estimated values. The figure illustrates the variances of estimated values in the case where the measurement time of the data used for temperature estimation is changed. Specifically, the figure illustrates the variances of the estimated values in the case where the data of 10 seconds, 15 seconds, and 30 seconds are used as measurement data. White circles are the variances of the estimated values in the case where estimation is performed by using the temperature estimation system 500 of this example, and black circles indicate the variances of estimated values according to the comparative example. In the comparative example, the temperature is estimated based only on the contact measurement data.

As illustrated in FIG. 4B, in the case where the temperature estimation system 500 of this example is used, the variance of the estimated values is approximately 0.1° C. even in the case where the data of 10 seconds is used. On the other hand, in the case where the comparative example is used, the variance of the estimated values is approximately 0.5° C. in the case where the data of 10 seconds is used, and the variance is large even when the data of 30 seconds is used. In this way, the temperature estimation system 500 of this example can more accurately estimate the temperature of the measurement target 10 in a short time than the case where the temperature of the measurement target 10 is estimated based on only the contact measurement data.

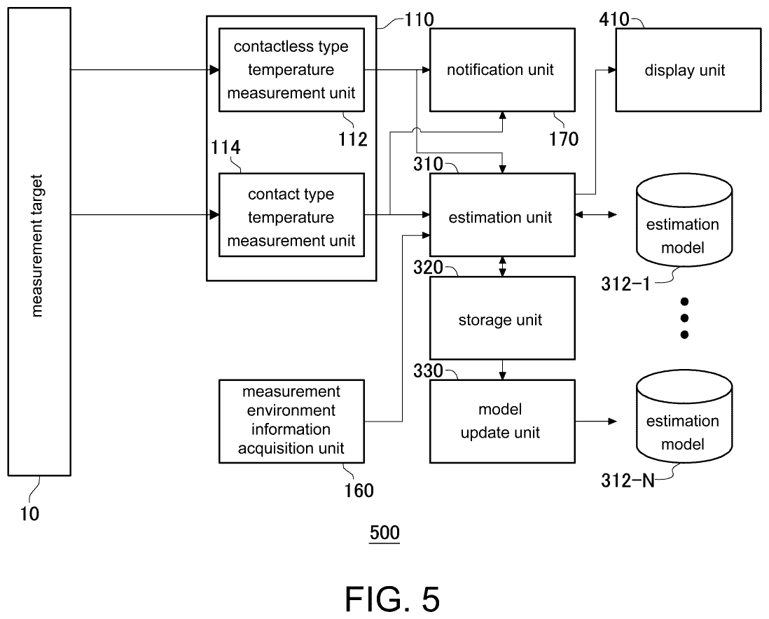

FIG. 5 illustrates a modified example of the configuration of the temperature estimation system 500 together with the measurement target 10. The temperature estimation system 500 may include a measurement related information acquisition unit 160, a notification unit 170, a storage unit 320, a model update unit 330, and a display unit 410.

The measurement related information acquisition unit 160 may acquire measurement related information relate to the measurement target 10 and the situation of measuring the temperature of the measurement target 10. The measurement related information acquisition unit 160 may acquire, as the measurement related information, the time when the measurement is performed, the ID of the measurement target 10, or the ID of the temperature measurement device having the contactless type temperature measurement unit 112 and the contact type temperature measurement unit 114, and the like. In the case where the measurement target 10 is a human body, the ID of the measurement target 10 may be identified by, for example, the input or selection of an account name, and the like, and may be identified by biometric authentication such as face authentication, fingerprint authentication, or voice authentication, and the like.

In the case where the measurement target 10 is a human body, the measurement related information acquisition unit 160 may acquire, as the measurement related information, gender, age, residential area, height, weight, body fat percentage, muscle mass, BMI, exercise habits, elapsed time from end of exercise, physiological variations such as menstrual cycle, stress, information on whether before or after meal, drinking state, measurement site such as ear, tongue or armpit, or medication history. In the case where the measurement target 10 is an animal, the measurement related information acquisition unit 160 may acquire, as the measurement related information, type of animal such as dog or cat, breed such as dog breed or cat breed, measurement site such as rectum, ear or abdomen, or estrus cycle.

The estimation model 312 may include multiple estimation models 312. The estimation model 312 includes, for example, N estimation models 312. The estimation unit 310 may select an estimation model 312 for estimating the temperature of the measurement target 10 from the estimation models 312. For example, the estimation unit 310 selects an estimation model 312 for estimating the temperature of the measurement target 10 from the estimation models 312 in response to the measurement related information. That is, the estimation models 312 may be models generated in advance so that estimation accuracy is improved in response to the measurement related information.

The estimation unit 310 may select the estimation model 312 in response to the time at which the measurement is performed. In the case where the measurement target 10 is a human body, since the tendency of the body temperature of the measurement target person can differ between, for example, morning and night, the tendency of the posterior probability distribution p(μ|Xnc,rep, Toffset, τ) may also change in response to the time at which the measurement is performed. Therefore, with the estimation unit 310 selecting the estimation model 312 in response to the time at which the measurement is performed, the temperature of the measurement target 10 can be estimated more accurately. In other words, the estimation model 312 may be generated in advance in response to the time at which the measurement is performed. For example, the estimation model 312 is generated for each predetermined time period.

The estimation unit 310 may select the estimation model 312 in response to the ID of the measurement target 10. In the case where the measurement target 10 is a human body, since there are individual differences in the body temperature of the measurement target person, there are also individual differences in the tendency of the posterior probability distribution p(μ|Xnc,rep, Toffset, τ). Therefore, with the estimation unit 310 selecting the estimation model 312 in response to the ID of the measurement target 10, the temperature of the measurement target 10 can be estimated more accurately. In other words, the estimation model 312 may be generated in advance in response to the ID of the measurement target 10.

The estimation unit 310 may select the estimation model 312 in response to the ID of the temperature measurement device. Since properties such as sensitivity of temperature measurement can differ for each temperature measurement device, the tendency of the posterior probability distribution p(μ|Xnc,rep, Toffset, τ) can also change for each temperature measurement device. Therefore, with the estimation unit 310 selecting the estimation model 312 in response to the ID of the temperature measurement device, the temperature of the measurement target 10 can be estimated more accurately. In other words, the estimation model 312 may be generated in advance in response to the ID of the temperature measurement device.

It is understood that the above selection method of the estimation model 312 may be implemented in a composite manner. That is, the estimation unit 310 may select the estimation model 312 according to any two of the time when the measurement is performed, the ID of the measurement target 10, or the ID of the temperature measurement device, and may select the estimation model 312 according to all of the time when the measurement is performed, the ID of the measurement target 10, and the ID of the temperature measurement device. In other words, the estimation model 312 may be generated in advance according to any two of the time when the measurement is performed, the ID of the measurement target 10, or the ID of the temperature measurement device, and may be generated in advance according to all of the time when the measurement is performed, the ID of the measurement target 10, and the ID of the temperature measurement device. The same applies in the case where the measurement related information include other information.

The notification unit 170 may notify that the quantity of the contact measurement values acquired from or after the rise time point of the contact measurement data has exceeded a predetermined reference value. For example, the reference value may be a sufficient quantity for accurately calculating the time constant τ and the temperature Toffset. The reference value may be the quantity of contact measurement values that should be acquired within 20 seconds from the rise time point of the contact measurement data, and may be the quantity of contact measurement values that should be acquired from the rise time point of the contact measurement data until the time point when the contact measurement data becomes 70% of the temperature difference dT. The notification unit 170 may perform notification based on the elapsed time from the rise time point of the contact measurement data. For example, the notification unit 170 notifies that 20 seconds have elapsed from the rise time point of the contact measurement data. The notification unit 170 may perform notification based on the contact measurement data. For example, the notification unit 170 notifies that the contact measurement data has become 70% of the temperature difference dT.

The storage unit 320 may store measurement history data including the contactless measurement data and the contact measurement data measured at multiple measurement opportunities. The measurement opportunities represent measurements performed at different dates and/or different times. The storage unit 320 may store the measurement history data together with identifiers representing the measurement opportunities. The storage unit 320 may store the measurement history data together with the temperature of the measurement target 10 estimated at the corresponding measurement opportunity. For example, the storage unit 320 stores in association the date and time when the measurement is performed, the contactless measurement data and the contact measurement data measured at the time, and the temperature of the measurement target 10 estimated based on the measurement data.

As described above, the estimation unit 310 may select an estimation model 312 for estimating the temperature of the measurement target 10 from the estimation models 312 in response to the measurement related information. Therefore, the estimation unit 310 may select different estimation models 312 at the measurement opportunities, and estimate the temperature of the measurement target 10 by using the selected estimation model 312. For example, the measurement related information includes the ID of the temperature measurement device. In this case, the estimation unit 310 may select a different model in response to the ID of the temperature measurement device having changed (for example, the temperature measurement device having been replaced, etc.). The storage unit 320 may store the measurement history data together with the information of the estimation model 312 used at the corresponding measurement opportunity (for example, a model ID, etc.).

The model update unit 330 may update the estimation model 312 based on the measurement history data. As described above, the estimation model 312 may be generated in advance. Meanwhile, the contactless measurement data and the contact measurement data acquired from time to time can serve as additional construction/learning data for improving the accuracy of the estimation model 312. Therefore, the model update unit 330 may update the estimation model 312 based on the measurement history data to improve the accuracy of the estimation model 312. The model update unit 330 may update the estimation model 312 in the case where a predetermined quantity of measurement history data has been accumulated since the estimation model 312 is constructed or since the estimation model 312 is last updated. The model update unit 330 may also update the estimation model 312 in the case where a predetermined period has elapsed since the estimation model 312 is constructed or since the estimation model 312 is last updated. The model update unit 330 may update each estimation model 312.

The model update unit 330 may update the estimation model 312 in response to the measurement related information. For example, the model update unit 330 updates the estimation model 312 in response to the measurement related information being updated.

The estimation unit 310 may also update the temperature of the measurement target 10 estimated at the past measurement opportunity based on the contactless measurement data and the contact measurement data measured at the past measurement opportunity of the measurement opportunities by using the updated estimation model 312. For example, in the case where the measurement target 10 is a human body, there are cases where diseases and the like can be predicted based on fluctuations in basal body temperature. In this case, the past basal body temperature may be referred to in order to confirm fluctuations in basal body temperature. The estimation unit 310 of the example updates the temperature of the measurement target 10 estimated at the past measurement opportunity by using the updated estimation model 312, that is, the estimation model 312 with improved accuracy. As a result, the temperature of the measurement target 10 can be estimated more accurately by going back to the past measurement opportunity, and the temperature of the measurement target 10 can be effectively utilized for prediction of diseases and the like.

The display unit 410 may display the temperature of the measurement target 10 estimated by the estimation unit 310. The display unit 410 may display the temperature of the measurement target 10 estimated by the estimation unit 310 for each measurement opportunity. The display unit 410 may display the temperature of the measurement target 10 estimated by the estimation unit 310 in the past measurement opportunity, for example, in response to an input from a user. In this case, in the case where the model update unit 330 updates the estimation model 312 and the estimation unit 310 updates the temperature of the measurement target 10, the display unit 410 may display the updated temperature of the measurement target 10.

The display unit 410 may display the transition of the temperature of the measurement target 10 estimated by the estimation unit 310. That is, the display unit 410 may display the temperatures of the measurement target 10 at multiple measurement opportunities from the past to the present. In the case where the model update unit 330 updates the estimation model 312 and the estimation unit 310 updates the temperatures of the measurement target 10 at past measurement opportunities, the display unit 410 may display the updated temperatures of the measurement target 10 as a portion of the transition. For example, in the case where the measurement target 10 is a human body, with the display unit 410 displaying the transition of the temperature of the measurement target 10, the temperature of the measurement target 10 can be effectively utilized for prediction of illness and the like.

The estimation unit 310 may determine whether the temperature of the measurement target 10 can be estimated based on the contactless measurement data acquired by the contactless type temperature measurement unit 112 and the contact measurement data acquired by the contact type temperature measurement unit 114. For example, the estimation unit 310 determines that the temperature of the measurement target 10 cannot be estimated in the case where the number of the contact measurement values included in the contact measurement data provided from the contact type temperature measurement unit 114 is not sufficient to accurately estimate the temperature of the measurement target 10. The estimation unit 310 may provide the determination result to the display unit 410. The display unit 410 may display a measurement error when the estimation unit 310 determines that the temperature of the measurement target 10 cannot be estimated.

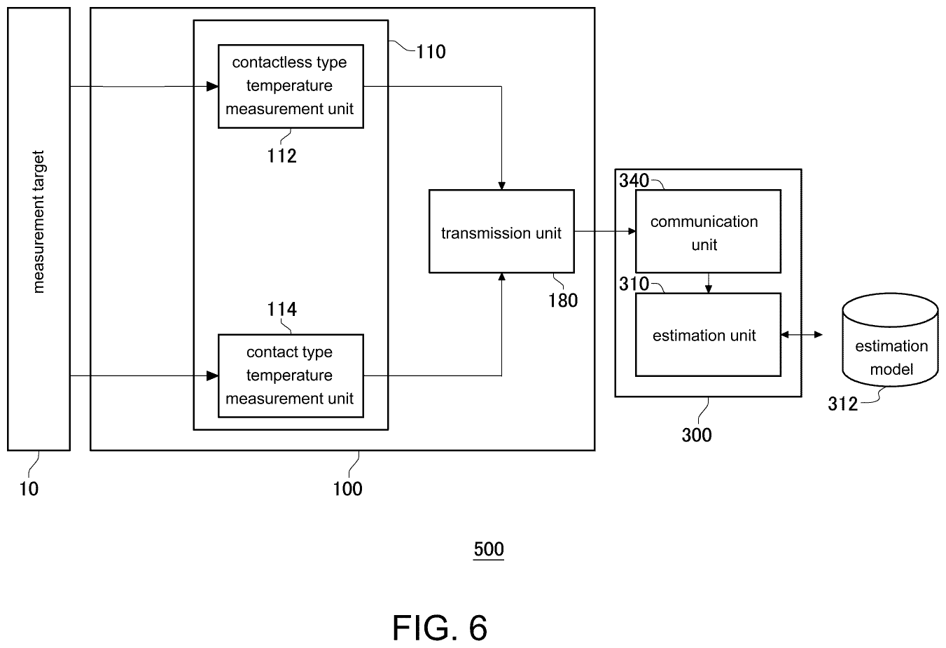

FIG. 6 illustrates a modified example of the configuration of the temperature estimation system 500 together with the measurement target 10. The temperature estimation system 500 of this example includes the temperature measurement device 100 and the estimation device 300. The figure indicates an example of the device configuration that embodies the temperature estimation system 500 of FIG. 1. However, the device configuration that embodies the temperature estimation system 500 is not limited to this example. For example, the temperature estimation system 500 may be embodied by a single device. Also, which configuration is included in which device is not limited to this example.

The temperature measurement device 100 includes the temperature measurement module 110 and a transmission unit 180. The temperature measurement module 110 has the contactless type temperature measurement unit 112 and the contact type temperature measurement unit 114. The contactless type temperature measurement unit 112 and the contact type temperature measurement unit 114 may be the same as those described with reference to FIG. 1 to FIG. 5.

The transmission unit 180 transmits measurement result information based on the contactless measurement data and the contact measurement data. The transmission unit 180 may also transmit the measurement result information to the estimation device 300. The measurement result information may be used for estimation of the temperature of the measurement target 10 in the estimation device 300.

The transmission unit 180 may transmit, as the measurement result information, at least one of the contactless measurement values and two or more contact measurement values among the contact measurement values. The at least one of the contactless measurement values may include a contactless measurement value representing the maximum of the contactless measurement data, may include other contactless measurement values, and may include a contactless measurement value representing 90% of the maximum of the contactless measurement data. The two or more contact measurement values among the contact measurement values may be two or more contact measurement values acquired from or after the rise time point of the contact measurement data, may be contact measurement values acquired within 20 seconds from the rise time point of the contact measurement data, and may be contact measurement values acquired from the rise time point of the contact measurement data until the time point when the contact measurement data becomes 70% of the temperature difference dT.

The transmission unit 180 may transmit the estimated parameters calculated based on the contactless measurement data and the contact measurement data as the measurement result information. The estimated parameters may include the temperature Toffset and the time constant τ. In the case where the transmission unit 180 transmits at least one of the contactless measurement values and two or more contact measurement values among the contact measurement values as the measurement result information, the estimated parameters may be calculated by the estimation device 300. That is, the estimated parameters may be calculated by the temperature measurement device 100 and transmitted to the estimation device 300, or may be calculated by the estimation device 300 based on the raw data transmitted from the temperature measurement device 100 to the estimation device 300.

The estimation device 300 includes the estimation unit 310 and a communication unit 340. The estimation unit 310 may be the same as that described with reference to FIG. 1 to FIG. 5. The estimation device 300 is, for example, a server device configured to be communicable with the temperature measurement device 100.

The communication unit 340 receives the measurement result information based on the contactless measurement data and the contact measurement data. The communication unit 340 may receive the measurement result information from the temperature measurement device 100. The communication unit 340 may receive at least one of the contactless measurement values and two or more contact measurement values among the contact measurement values as the measurement result information, and may receive the estimated parameters calculated based on the contactless measurement data and the contact measurement data as the measurement result information. The communication unit 340 may supply the measurement result information to the estimation unit 310. The estimation unit 310 estimates the temperature of the measurement target 10 based on the measurement result information by using the predetermined estimation model 312.

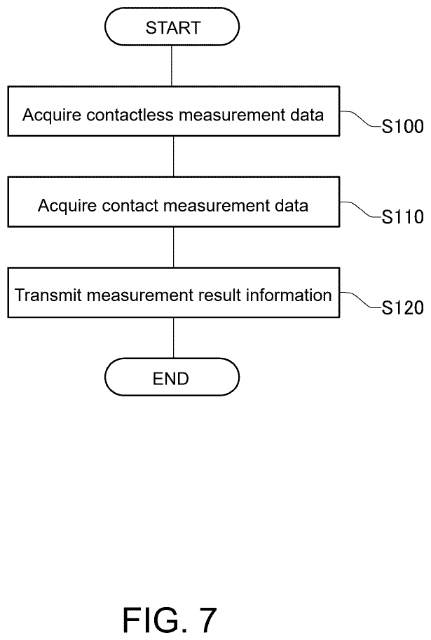

An arithmetic circuit built in the temperature measurement device 100 may have a limited arithmetic processing capability due to, for example, a size constraint. Therefore, the arithmetic based on the statistical estimation method or the arithmetic based on machine learning in the temperature estimation system 500 of this example may be impossible to execute in the arithmetic circuit built in the temperature measurement device 100, or may require an enormous amount of time. The temperature estimation system 500 of the example can estimate the temperature of the measurement target 10 at a high speed on, for example, a server device by providing the estimation device 300 separately.
FIG. 7 illustrates an example of a temperature measurement method. The temperature measurement method of this example is a method embodied by, for example, the temperature measurement device 100 of FIG. 6.

In Step S100, the contactless type temperature measurement unit 112 of the temperature measurement device 100 measures the temperature of the measurement target 10 and acquires the contactless measurement data including multiple contactless measurement values. In Step S110, the contact type temperature measurement unit 114 of the temperature measurement device 100 measures the temperature of the measurement target 10 and acquires the contact measurement data including multiple contact measurement values. Step S100 and Step S110 are steps that are performed in parallel, as illustrated in FIG. 2A and FIG. 2B, for example. From Step S100 to Step S110, the temperature measurement device 100 may transition from a state of not contacting the measurement target 10 to a state of contacting the measurement target 10. With the temperature measurement device 100 transitioning from a state of not contacting the measurement target 10 to a state of contacting the measurement target 10, a peak of the contactless measurement data and a rise of the contact measurement data may be observed.

In Step S120, the measurement result information based on the contactless measurement data and the contact measurement data is transmitted. Step S120 of transmitting the measurement result information may include a step of transmitting at least one of thecontactless measurement values and two or more contact measurement values among the contact measurement values as the measurement result information, and may include a step of transmitting the estimated parameter calculated based on the contactless measurement data and the contact measurement data as the measurement result information.

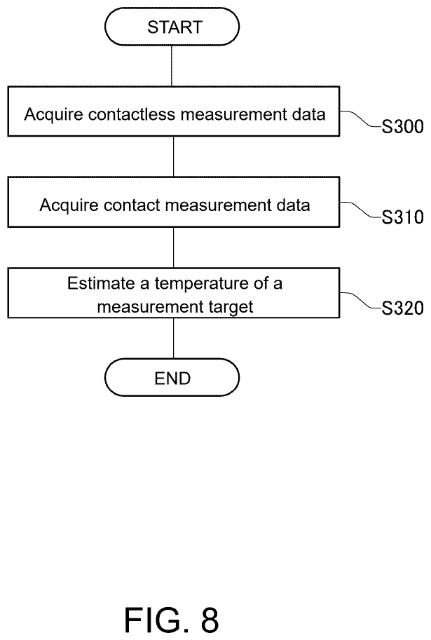

FIG. 8 illustrates an example of a temperature estimation method. The temperature estimation method of this example is a method embodied by, for example, the estimation device 300 of FIG. 6.

In Step S300, the contactless measurement data including multiple contactless measurement values acquired by measuring the temperature of the measurement target 10 by using the contactless type temperature measurement unit 112 of the temperature measurement device 100 is acquired. In Step S310, the contact measurement data including the contact measurement values acquired by measuring the temperature of the measurement target 10 using the contact type temperature measurement unit 114 of the temperature measurement device 100 is acquired. For example, the communication unit 340 of the estimation device 300 acquires the measurement result information based on the contactless measurement data and the contact measurement data from the transmission unit 180 of the temperature measurement device 100. That is, Step S300 and Step S310 may be steps that are executed in parallel.

In Step S320, the temperature of the measurement target 10 is estimated based on the contactless measurement data and the contact measurement data by using a predetermined estimation model 312. The details of Step S320 for estimating the temperature of the measurement target 10 may be the same as the operation of the estimation unit 310 described with reference to FIG. 1 to FIG. 5.

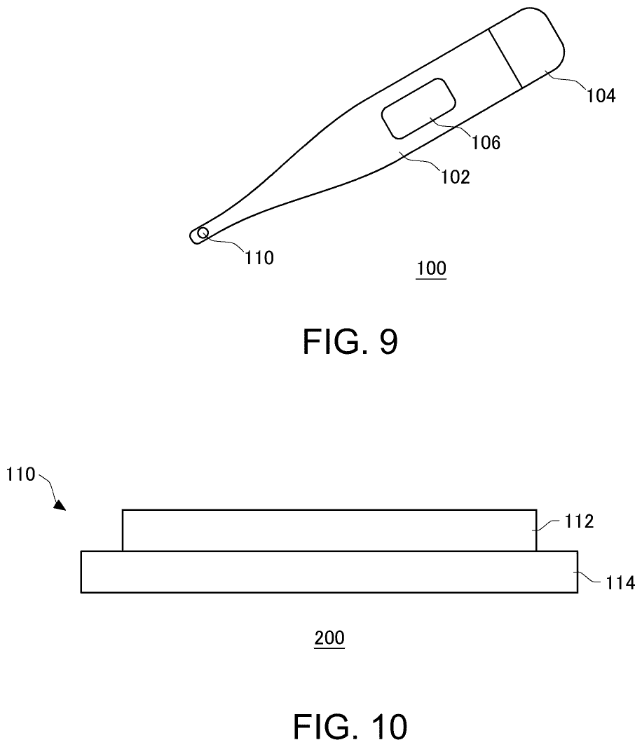

FIG. 9 illustrates an example of the temperature measurement device 100. The temperature measurement device 100 of this example is an example of a temperature measurement device that embodies the configuration of FIG. 6. For example, the measurement target 10 is a human body, and the temperature measurement device 100 is a clinical thermometer that measures the temperature of the human body.

The temperature measurement device 100 may include a main body part 102, a cover part 104, and a display unit 106. Inside the main body part 102, for example, an arithmetic circuit is provided, and the arithmetic circuit may be accommodated by the main body part 102 and the cover part 104. The temperature measurement module 110 may be provided in the vicinity of the tip on the side of the main body part 102 opposite to the cover part 104. The temperature measurement module 110 may be controlled by an arithmetic circuit built in the main body part 102. The transmission unit 180 may be realized by an arithmetic circuit built in the main body part 102 and a communication antenna, etc.

The temperature measurement device 100 may measure the temperature of the measurement target 10 in a process of transitioning from a state where the temperature measurement device 100 does not contact the measurement target 10 to a state where the temperature measurement device 100 contacts the measurement target 10. More specifically, the temperature measurement device 100 may measure the temperature of the measurement target 10 in a process of transitioning from a state where the vicinity of the tip where the temperature measurement module 110 is provided does not contact the measurement target 10 to a state where the tip contacts the measurement target 10. For example, the temperature measurement device 100 measures the temperature of the measurement target 10 in a process of transitioning from a state where the tip thereof is not held under the armpit of the human body to a state where the tip approaches the armpit and is held under the armpit. However, the body part that the temperature measurement device 100 measures is not limited to the armpit.

FIG. 10 illustrates an example of a semiconductor package 200. The semiconductor package 200 is an example of the temperature measurement module 110. The semiconductor package 200 may have the contactless type temperature measurement unit 112 and the contact type temperature measurement unit 114. That is, the contactless type temperature measurement unit 112 and the contact type temperature measurement unit 114 may be provided in the common semiconductor package 200.

For example, the contactless type temperature measurement unit 112 has a radiation thermometer that measures a temperature based on the radiation from the measurement target 10. The contact type temperature measurement unit 114 may have a large-scale integrated circuit capable of measuring the temperature by contacting the measurement target 10. That is, the semiconductor package 200 may be configured by providing a radiation sensor above a large-scale integrated circuit capable of measuring the temperature by contacting the measurement target 10.

The radiation thermometer that the contactless type temperature measurement unit 112 has may measure the temperature of the measurement target 10 based on the radiation from the measurement target 10 and the temperature that the contact type temperature measurement unit 114 measured. That is, the contact type temperature measurement unit 114 may serve as a built-in thermometer of the contactless type temperature measurement unit 112. In this way, the contactless type temperature measurement unit 112 and the contact type temperature measurement unit 114 may be provided in the common semiconductor package 200, and the contact type temperature measurement unit 114 may serve as a built-in thermometer of the contactless type temperature measurement unit 112.

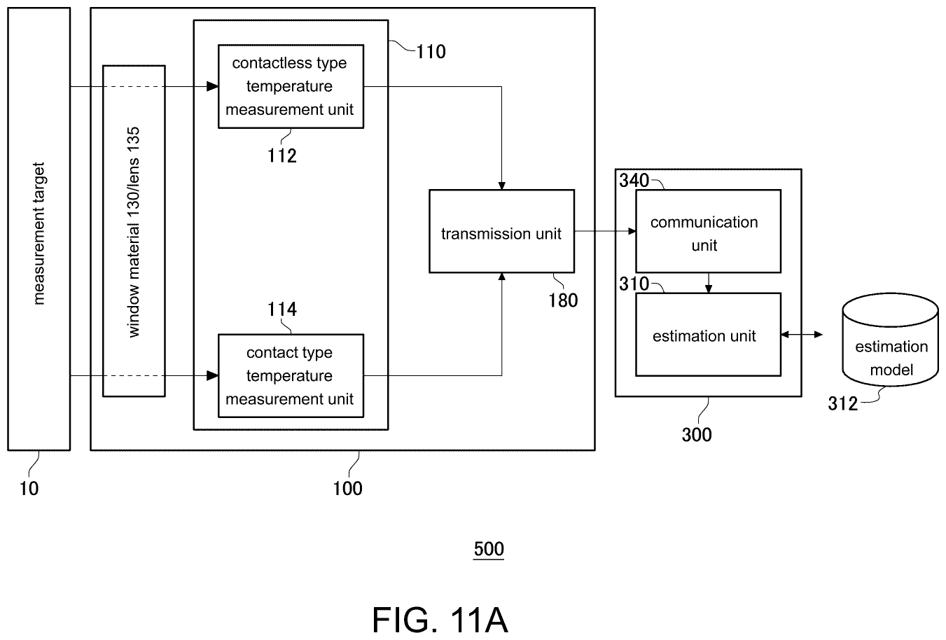

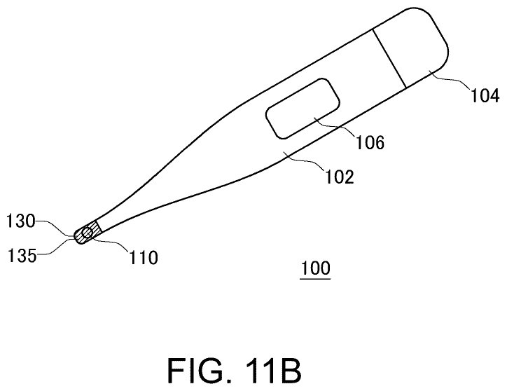

FIG. 11A illustrates a modified example of the configuration of the temperature estimation system 500 together with the measurement target 10. The temperature estimation system 500 of this example differs from the embodiment of FIG. 6 in that the temperature measurement device 100 includes a window material 130 or a lens 135. Others may be the same as the embodiment of FIG. 6.

The contactless type temperature measurement unit 112 may measure the temperature of the measurement target 10 through the window material 130 or the lens 135 to acquire the contactless measurement data. The contact type temperature measurement unit 114 may measure the temperature of the measurement target 10 through the window material 130 or the lens 135 to acquire the contact measurement data.

The window material 130 may be a member that transmits at least a portion of a predetermined wavelength band. As an example, the window material 130 is a member that transmits at least a portion of a wavelength band from 4 μm to 10 μm. The window material 130 may be, for example, an optical filter. For example, the material of the window material 130 may be any of silicon, germanium, sapphire, diamond, calcium fluoride, barium fluoride, potassium bromide, zinc selenide, zinc sulfide, chalcogenide glass, or quartz.

The lens 135 may be a Fresnel lens or a spherical lens. The lens 135 may include a function of transmitting at least a portion of a predetermined wavelength band. The window material 130 and the lens 135 may be the same part, may be multiple parts integrated, and may be present as separate bodies.

FIG. 11B illustrates a modified example of the temperature measurement device 100. The temperature measurement device 100 of this example is an example of a temperature measurement device that embodies the configuration of FIG. 11A. The window material 130 or the lens 135 may be provided so as to cover the temperature measurement module 110 in the vicinity of the tip of the main body part 102 where the temperature measurement module 110 is provided. The window material 130 may protect the temperature measurement module 110 from dirt or dust and the like. The lens 135 may focus radiation from the measurement target 10 onto the contactless type temperature measurement unit 112.

In the case where the temperature measurement module 110 is covered by the window material 130, the radiation quantity observed by the contactless type temperature measurement unit 112 is reduced, and the contactless measurement data may change. Also, in the case where the temperature measurement module 110 is covered by the window material 130, the heat conduction properties from the measurement target 10 may change, and the contact measurement data may change. The estimation model 312 may be generated in consideration of the window material 130. Similarly, the estimation model 312 may be generated in consideration of the lens 135.

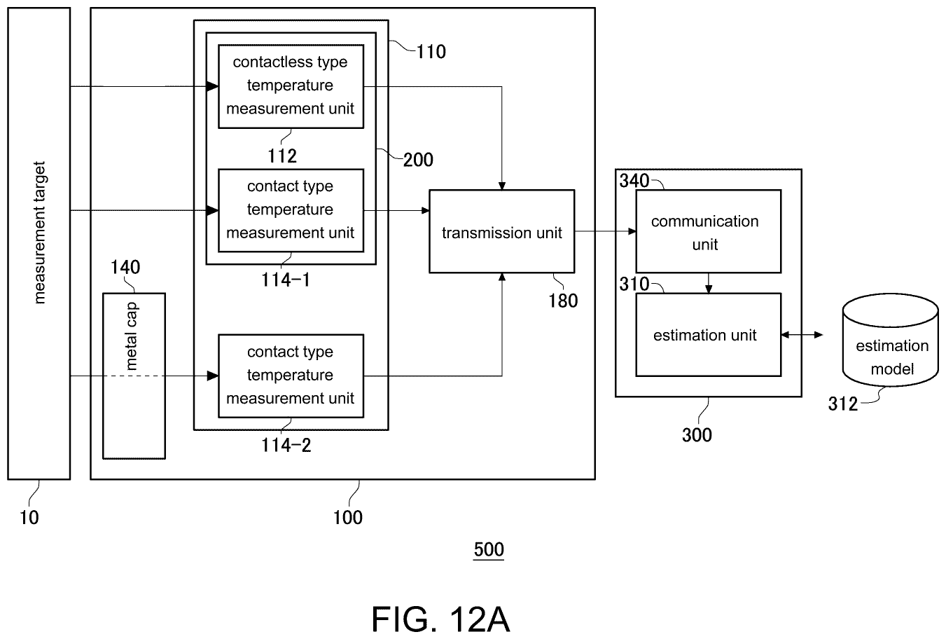

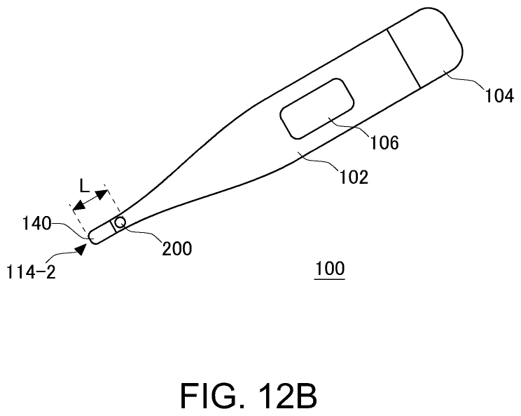

FIG. 12A illustrates a modified example of the configuration of the temperature estimation system 500 together with the measurement target 10. The temperature estimation system 500 of this example differs from the embodiment of FIG. 6 in that the temperature measurement device 100 includes multiple contact type temperature measurement units 114. Others may be the same as the embodiment of FIG. 6.

The temperature measurement device 100 may include the contactless type temperature measurement unit 112 and a contact type temperature measurement unit 114-1 provided in the common semiconductor package 200, as well as a contact type temperature measurement unit 114-2 provided separately from the semiconductor package 200. The contact type temperature measurement unit 114-2 may measure the temperature of the measurement target 10 through a metal cap 140 to acquire the contact measurement data. For example, the contact type temperature measurement unit 114-2 has a platinum resistance.

FIG. 12B illustrates a modified example of the temperature measurement device 100. The temperature measurement device 100 of this example is an example of a temperature measurement device that embodies the configuration of FIG. 12A.

The contact type temperature measurement unit 114-2 may be provided in the vicinity of the tip of the main body part 102. The semiconductor package 200 may be provided closer to the center side of the main body part 102 than the contact type temperature measurement unit 114-2 in the vicinity of the tip of the main body part 102. In this way, the temperature measurement device 100 of this example may be realized by adding the semiconductor package 200 to an existing temperature measurement device that does not include the semiconductor package 200 and includes only the contact type temperature measurement unit 114-2.

The distance between the contactless type temperature measurement unit 112 and the contact type temperature measurement unit 114 may be within 5 cm, and may be within 3 cm. The distance between the contactless type temperature measurement unit 112 and the contact type temperature measurement unit 114 may be a distance L between the most separated parts of the contactless type temperature measurement unit 112 and the contact type temperature measurement unit 114. That is, in FIG. 12B, L may be within 5 cm, and may be within 3 cm. Accordingly, since the position of the measurement target 10 that the contactless type temperature measurement unit 112 measures and the position of the measurement target 10 that the contact type temperature measurement unit 114 measures become substantially the same, the temperature of the measurement target 10 can be accurately estimated. The contactless type temperature measurement unit 112 and the contact type temperature measurement unit 114 may be located within 5 cm or within 3 cm by being provided in the common semiconductor package 200 like the contactless type temperature measurement unit 112 and the contact type temperature measurement unit 114-1, and may be located within 5 cm or within 3 cm while being provided separately like the contactless type temperature measurement unit 112 and the contact type temperature measurement unit 114-2.

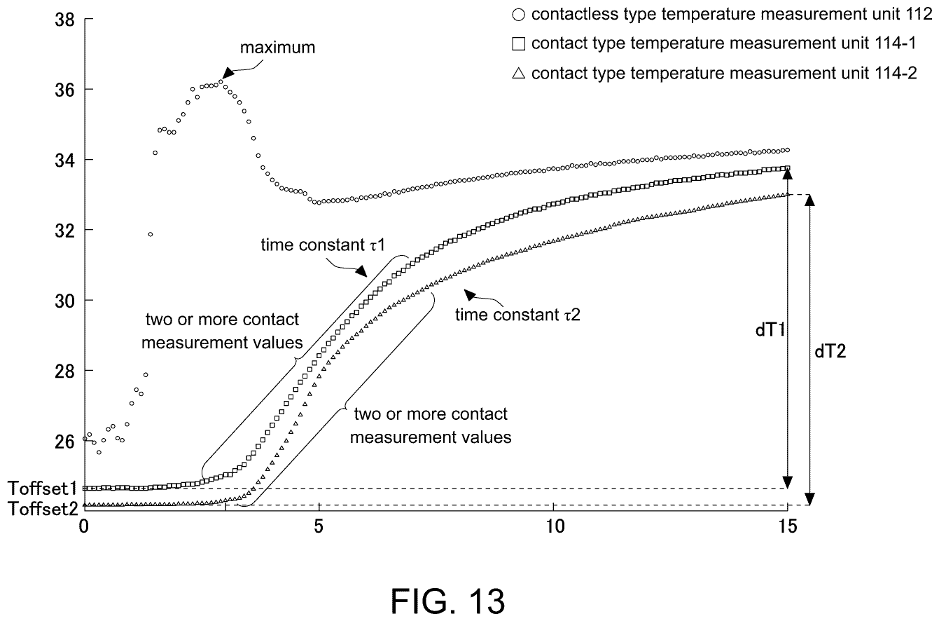

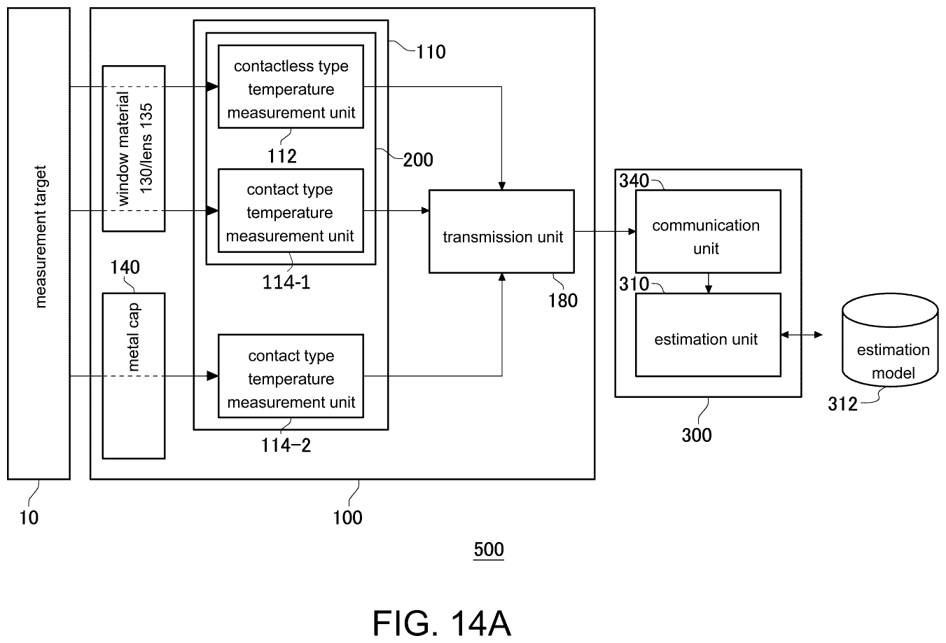

FIG. 13 illustrates an example of temporal changes of measurement data. In this figure, the horizontal axis represents time, and the vertical axis represents temperature acquired as measurement data. White circles represent temperatures acquired by the contactless type temperature measurement unit 112 as the contactless measurement data, white squares represent temperatures acquired by the contact type temperature measurement unit 114-1 as the contact measurement data, and white triangles represent temperatures acquired by the contact type temperature measurement unit 114-2 as the contact measurement data. Each of the white circles is a contactless measurement value, each of the white squares is a contact measurement value, and each of the white triangles is a contact measurement value.

The transmission unit 180 may transmit, as the measurement result information, at least one of the contactless measurement values and two or more contact measurement values among the contact measurement values. The transmission unit 180 may transmit, as the contact measurement values, at least one of the two or more contact measurement values among the contact measurement values acquired by the contact type temperature measurement unit 114-1 or the two or more contact measurement values among the contact measurement values acquired by the contact type temperature measurement unit 114-2.

The transmission unit 180 may transmit the estimated parameters calculated based on the contactless measurement data and the contact measurement data as the measurement result information. The estimated parameters may include the temperature Toffset and the time constant τ. The transmission unit 180 may transmit, as the estimated parameters, at least one of a temperature Toffset1 and a time constant τ1 calculated based on the contact measurement data acquired by the contact type temperature measurement unit 114-1 or a temperature Toffset2 and a time constant τ2 calculated based on the contact measurement data acquired by the contact type temperature measurement unit 114-2.

The estimation unit 310 estimates the temperature of the measurement target 10 based on the contactless measurement data and the contact measurement data by using a predetermined estimation model 312. The estimation unit 310 may estimate the temperature of the measurement target 10 based on at least one of the contact measurement data acquired by the contact type temperature measurement unit 114-1 or the contact measurement data acquired by the contact type temperature measurement unit 114-2. That is, the estimation model 312 may be generated in advance based on the contactless measurement data and the contact measurement data acquired by the contact type temperature measurement unit 114-1, may be generated in advance based on the contactless measurement data and the contact measurement data acquired by the contact type temperature measurement unit 114-2, and may be generated in advance based on the contactless measurement data, the contact measurement data acquired by the contact type temperature measurement unit 114-1, and the contact measurement data acquired by the contact type temperature measurement unit 114-2.

The estimation unit 310 may input at least one of the contactless measurement values and two or more contact measurement values among the contact measurement values to the estimation model 312 to estimate the temperature of the measurement target 10. The estimation unit 310 may input to the estimation model 312, as the two or more contact measurement values among the contact measurement values, at least one of the two or more contact measurement values among the contact measurement values acquired by the contact type temperature measurement unit 114-1 or the two or more contact measurement values among the contact measurement values acquired by the contact type temperature measurement unit 114-2.

The estimation unit 310 may also input the estimated parameters calculated based on the contactless measurement data and the contact measurement data to the estimaetion model 312 to estimate the temperature of the measurement target 10. The estimation unit 310 may input to the estimation model 312, as the estimated parameters, at least one of the temperature Toffset1 and the time constant τ1 calculated based on the contact measurement data acquired by the contact type temperature measurement unit 114-1, or the temperature Toffset2 and the time constant τ2 calculated based on the contact measurement data acquired by the contact type temperature measurement unit 114-2.

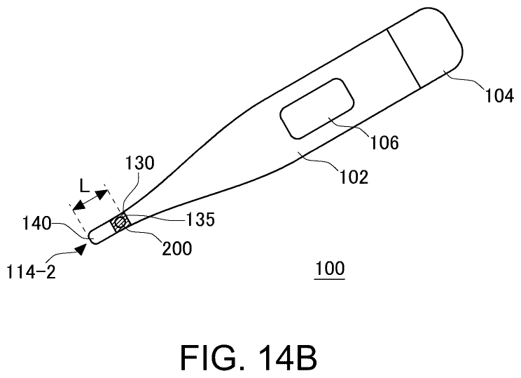

FIG. 14A illustrates a modified example of the configuration of the temperature estimation system 500 together with the measurement target 10. The temperature estimation system 500 of this example differs from the embodiment of FIG. 12A in that the temperature measurement device 100 includes the window material 130 or the lens 135. Others may be the same as the embodiment of FIG. 12A.

The contactless type temperature measurement unit 112 may measure the temperature of the measurement target 10 through the window material 130 or the lens 135 to acquire the contactless measurement data. The contact type temperature measurement unit 114-1 may measure the temperature of the measurement target 10 through the window material 130 or the lens 135 to acquire the contact measurement data.

FIG. 14B illustrates a modified example of the temperature measurement device 100. The temperature measurement device 100 of this example is an example of a temperature measurement device that embodies the configuration of FIG. 14A. The window material 130 or the lens 135 may be provided so as to cover the temperature measurement module 110 in the vicinity of the tip of the main body part 102 where the temperature measurement module 110 is provided. The window material 130 may protect the temperature measurement module 110 from dirt or dust and the like. The lens 135 may focus radiation from the measurement target 10 onto the contactless type temperature measurement unit 112.

In the case where the temperature measurement module 110 is covered by the window material 130, the radiation quantity observed by the contactless type temperature measurement unit 112 is reduced, and the contactless measurement data may change. Also, in the case where the temperature measurement module 110 is covered by the window material 130, the heat conduction properties from the measurement target 10 may change, and the contact measurement data may change. The estimation model 312 may be generated in consideration of the window material 130. Similarly, the estimation model 312 may be generated in consideration of the lens 135.

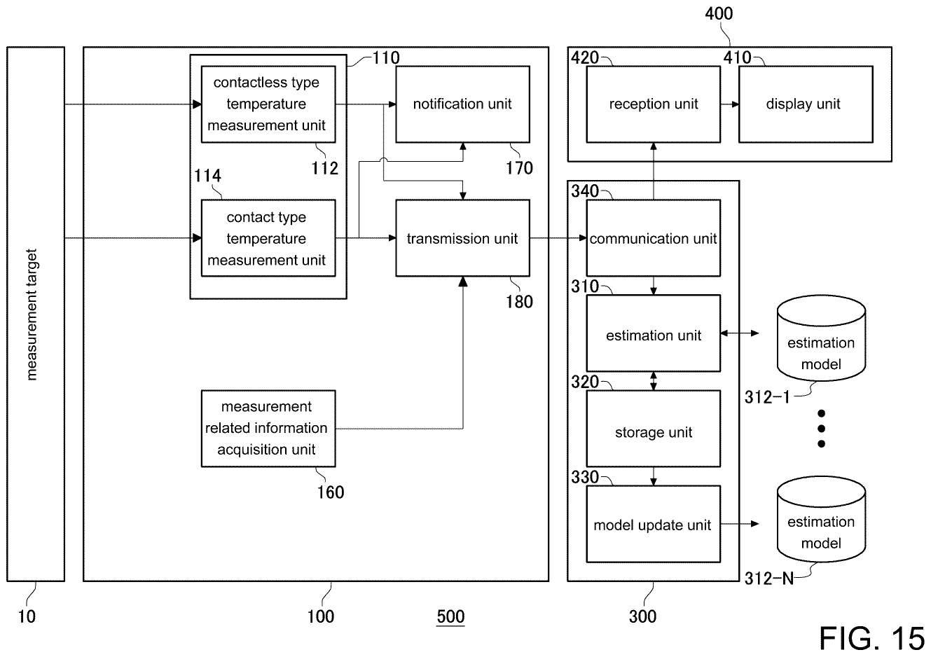

FIG. 15 illustrates a modified example of the configuration of the temperature estimation system 500 together with the measurement target 10. The temperature estimation system 500 of this example includes the temperature measurement device 100, the estimation device 300, and a display device 400. The figure indicates an example of the device configuration that embodies the temperature estimation system 500 of FIG. 5. However, the device configuration that embodies the temperature estimation system 500 is not limited to this example. For example, the temperature measurement device 100 and the display device 400 may be embodied with a single device, the temperature measurement device 100 and the estimation device 300 may be embodied with a single device, the estimation device 300 and the display device 400 may be embodied with a single device, and all the configurations of the temperature estimation system 500 may be embodied by a single device. Also, which configuration is included in which device is not limited to this example.

In this example, the points that differ from the embodiment of FIG. 6 are particularly described. Others may be the same as the embodiment of FIG. 6. The temperature measurement device 100 may include the measurement related information acquisition unit 160 and the notification unit 170. The estimation device 300 may include the storage unit 320 and the model update unit 330. The display device 400 includes the display unit 410. The display device 400 may include a reception unit 420.

The measurement related information acquisition unit 160 may acquire the measurement related information related to the measurement target 10 and the situation of measuring the temperature of the measurement target 10. The details of the measurement related information acquisition unit 160 and the measurement related information may be the same as those described with reference to FIG. 5.

The transmission unit 180 may transmit the measurement result information and the measurement related information. The transmission unit 180 may transmit the measurement result information and the measurement related information to the estimation device 300.

At least a portion of the measurement related information may be acquired in the estimation device 300. For example, the estimation device 300 may acquire the time when the measurement result information is received from the temperature measurement device 100 as the time when the measurement is performed.

The notification unit 170 may notify that the quantity of the contact measurement values acquired from or after the rise time point of the contact measurement data has exceeded a predetermined reference value. The details of the notification unit 170 may be the same as those described with reference to FIG. 5. The notification unit 170 may notify by sound, may notify by displaying on the display unit 106, and may notify by vibration.

The storage unit 320 may store measurement history data including the contactless measurement data and the contact measurement data measured at multiple measurement opportunities. The model update unit 330 may update the estimation model 312 based on the measurement history data. Details of the operations of the storage unit 320 and the model update unit 330, as well as the estimation unit 310 related thereto, may be the same as those described with reference to FIG. 5.

The communication unit 340 may receive the measurement result information and the measurement related information from the temperature measurement device 100. The communication unit 340 may supply the measurement result information and the measurement related information to the estimation unit 310.

The estimation unit 310 may select an estimation model 312 for estimating the temperature of the measurement target 10 from the estimation models 312 in response to the measurement related information. The details of the measurement related information and the operation of the estimation unit 310 may be the same as those described with reference to FIG. 5.

The communication unit 340 may transmit the temperature of the measurement target 10 estimated by the estimation unit 310 to the display device 400. The communication unit 340 may transmit the temperature of the measurement target 10 estimated by the estimation unit 310 at multiple measurement opportunities from the past to the present to the display device 400. In the case where the model update unit 330 updates the estimation model 312 and the estimation unit 310 updates the temperatures of the measurement target 10 at past measurement opportunities, the communication unit 340 may transmit the updated temperatures of the measurement target 10 to the display device 400. The communication unit 340 may transmit a result of determining whether the estimation unit 310 can estimate the temperature of the measurement target 10 to the display device 400.

The display device 400 may be, for example, a personal computer (PC), a tablet computer, a smartphone, a smartwatch, AR/VR goggles, or smart glasses configured to be communicable with the estimation device 300. In this way, for example, in the case where the measurement target 10 is a human body, the usability in health management can be improved.

The reception unit 420 may receive the temperature of the measurement target 10 estimated by the estimation unit 310 from the estimation device 300. The reception unit 420 may receive the temperatures of the measurement target 10 estimated by the estimation unit 310 at the measurement opportunities from the past to the present from the estimation device 300. In the case where the model update unit 330 updates the estimation model 312 and the estimation unit 310 updates the temperatures of the measurement target 10 at past measurement opportunities, the reception unit 420 may receive the updated temperatures of the measurement target 10 from the estimation device 300. The reception unit 420 may receive a result of determining whether the estimation unit 310 can estimate the temperature of the measurement target 10 from the estimation device 300.

The display unit 410 may display the temperature of the measurement target 10 estimated by the estimation unit 310. The display unit 410 may display the transition of the temperature of the measurement target 10 estimated by the estimation unit 310. The display unit 410 may display a measurement error when the estimation unit 310 determines that the temperature of the measurement target 10 cannot be estimated. The details of the display unit 410 may be the same as those described with reference to FIG. 5.

Various embodiments of the invention may be described with reference to flowcharts and block diagrams, where blocks may represent (1) stages of a process in which operations are performed or (2) sections of a device having a role of performing operations. Specific stages and sections may be implemented by dedicated circuits, programmable circuits supplied with computer readable instructions stored on computer readable media, and/or processors supplied with computer readable instructions stored on computer readable media. Dedicated circuits may include digital and/or analog hardware circuits, and may include integrated circuits (IC) and/or discrete circuits. Programmable circuits may include reconfigurable hardware circuits including memory elements such as logical AND, logical OR, logical XOR, logical NAND, logical NOR, and other logical operations, flip-flops, registers, field programmable gate arrays (FPGA), programmable logic arrays (PLA), and the like.

The computer readable medium may include any tangible device capable of storing instructions executed by an appropriate device, and, as a result, a computer readable medium having instructions stored therein may include a product including instructions that can be executed to create means for executing operations specified in flowcharts or block diagrams. Examples of the computer readable medium may include an electronic storage medium, a magnetic storage medium, an optical storage medium, an electromagnetic storage medium, a semiconductor storage medium, and the like. More specific examples of the computer readable medium may include a floppy (registered trademark) disk, a diskette, hard disk, a random access memory (RAM), a read only memory (ROM), an erasable programmable read only memory (EPROM or flash memory), an electrically erasable programmable read only memory (EEPROM), a static random access memory (SRAM), a compact disc read only memory (CD-ROM), a digital versatile disc (DVD), a Blu-ray® disc, memory stick, an integrated circuit card, and the like.

The computer readable instructions may include either source codes or object codes written in any combination of one or more programming languages, including assembler instructions, instruction set architecture (ISA) instructions, machine instructions, machine dependent instructions, microcode, firmware instructions, state setting data, or object oriented programming languages such as Smalltalk (registered trademark), JAVA (registered trademark), C++, and the like, and conventional procedural programming languages such as the “C” programming language or similar programming languages.

Computer readable instructions may be provided to a processor or a programmable circuit of a programmable data processing device such as a computer, either locally or via a wide area network (WAN) such as a local area network (LAN), the Internet, or the like, and the computer readable instructions may be executed to create means for executing operations specified in flowcharts or block diagrams. Here, the computer may be a personal computer (PC), a tablet computer, a smartphone, a workstation, a server computer, a general-purpose computer, or a special-purpose computer, or the like, and may be a computer system in which multiple computers are connected. Such a computer system in which multiple computers are connected is also referred to as a distributed computing system, and is a computer in a broad sense. In a distributed computing system, each of the computers executes a portion of a program, and data during program execution is passed between computers as necessary. Accordingly, the computers collectively execute the program.

Examples of processors include computer processors, central processing units (CPUs), processing units, microprocessors, digital signal processors, controllers, microcontrollers, and the like. A computer may include one processor or multiple processors. In a multiprocessor system including multiple processors, each processor executes a portion of a program, and by passing data during program execution between processors as needed, the processors collectively execute the program. For example, in the execution of multitasking, each of the processors may execute a portion of each task each in small pieces by performing task switching for each time slice. In this case, which portion of one program each processor executes changes dynamically. Which portion of the program each of the processors executes may also be defined statically by programming that is aware of multiprocessors.

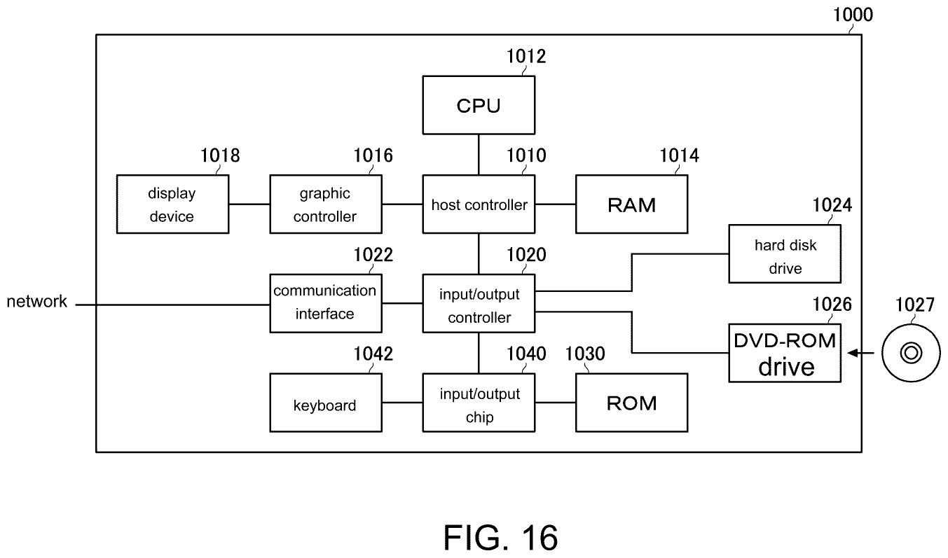

FIG. 16 illustrates an example of a computer 1000 in which multiple aspects of the invention may be embodied in whole or in part. A program installed in the computer 1000 can cause the computer 1000 to serve as operations associated with a device according to an embodiment of the invention or as one or multiple sections of the device, or can cause the computer 1000 to execute the operations or the one or multiple sections, and/or can cause the computer 1000 to execute a process according to an embodiment of the invention or stages of the process. Such a program may be executed by the CPU 1012 to cause the computer 1000 to execute specific operations associated with some or all of the flowcharts and the blocks of the block diagrams described in the specification.

The computer 1000 according to the embodiment includes a CPU 1012, the RAM 1014, a graphic controller 1016, and a display device 1018, which are mutually connected by a host controller 1010. The computer 1000 also includes input/output units such as a communication interface 1022, a hard disk drive 1024, a DVD-ROM drive 1026, and an IC card drive, which are connected to the host controller 1010 via an input/output controller 1020. The computer also includes legacy input/output units such as a ROM 1030 and a keyboard 1042, which are connected to the input/output controller 1020 via an input/output chip 1040.

The CPU 1012 operates according to programs stored in the ROM 1030 and the RAM 1014, thereby controlling each unit. The graphic controller 1016 acquires image data generated by the CPU 1012 in a frame buffer or the like provided in the RAM 1014 or in itself, and causes the image data to be displayed on the display device 1018.

The communication interface 1022 communicates with other electronic devices via a network. The hard disk drive 1024 stores programs and data used by the CPU 1012 in the computer 1000. The DVD-ROM drive 1026 reads the programs or data from the DVD-ROM 1027, and provides the programs or data to the hard disk drive 1024 via the RAM 1014. The IC card drive reads the programs and data from an IC card, and/or writes programs and data to the IC card.

The ROM 1030 stores therein a boot program or the like executed by the computer 1000 at the time of activation, and/or a program dependent on the hardware of the computer 1000. The input/output chip 1040 may also connect various input/output units to the input/output controller 1020 via a parallel port, a serial port, a keyboard port, a mouse port, or the like.

The program is provided by a computer readable medium such as the DVD-ROM 1027 or an IC card. The program is read from the computer readable medium, installed in the hard disk drive 1024, the RAM 1014, or the ROM 1030 which is also an example of the computer readable medium, and executed by the CPU 1012. The information processing described in the programs is read by the computer 1000 and brings about the cooperation between the programs and various types of hardware resources above. A device or method may be configured by realizing manipulation or processing of information according to the use of the computer 1000.

For example, in the case where the communication is executed between the computer 1000 and an external device, the CPU 1012 may execute a communication program loaded to the RAM 1014, and instruct the communication interface 1022 to perform communication processing based on the process described in the communication program. The communication interface 1022, under the control of the CPU 1012, reads the transmission data stored in a transmission buffer processing area provided in a recording medium such as the RAM 1014, the hard disk drive 1024, the DVD-ROM 1027, or an IC card, transmits the read transmission data to a network, or writes reception data received from the network to a reception buffer processing area or the like provided in the recording medium.

In addition, the CPU 1012 may cause all or a necessary portion of a file or a database stored in an external recording medium such as the hard disk drive 1024, the DVD-ROM drive 1026 (DVD-ROM 1027), an IC card, or the like to be read into the RAM 1014, and may execute various types of processing on the data on the RAM 1014. The CPU 1012 then writes back the processed data to the external recording medium.

Various types of information such as various types of programs, data, tables, and databases may be stored in the recording medium and may be subjected to information processing. The CPU 1012 may execute various types of processing on data read from the RAM 1014, including various types of operations, information processing, condition judgment, conditional branching, unconditional branching, information search/replacement, and the like, described throughout the invention and specified by instruction sequences of programs, and write back the results to the RAM 1014. Also, the CPU 1012 may search for information in files, databases, and the like in the recording medium. For example, in the case where multiple entries each having an attribute value of a first attribute associated with an attribute value of a second attribute are stored in the recording medium, the CPU 1012 may search for an entry matching a condition in which an attribute value of the first attribute is specified from among the entries, read an attribute value of the second attribute stored in the entry, and thereby acquire an attribute value of the second attribute associated with the first attribute satisfying a predetermined condition.

The program or software module described above may be stored in a computer readable medium on the computer 1000 or in the vicinity of the computer 1000. Also, a recording medium such as a hard disk or RAM provided in a server system connected to a dedicated communication network or the Internet can be used as a computer readable medium, thereby providing the program to the computer 1000 via the network.

The embodiment may be specified by the following items.

### Item 1

A temperature estimation system includes: an estimation unit, estimating a temperature of a measurement target by using a predetermined estimation model based on contactless measurement data and contact measurement data acquired by measuring the temperature of the measurement target; and a storage unit, storing measurement history data including the contactless measurement data and the contact measurement data measured at multiple measurement opportunities.

### Item 2

The temperature estimation system according to Item 1 includes: a model update unit, updating the estimation model based on the measurement history data.

### Item 3

In the temperature estimation system according to Item 2, by using the updated estimation model, the estimation unit corrects the temperature of the measurement target estimated based on the contactless measurement data and the contact measurement data measured at past measurement opportunities of the measurement opportunities.

### Item 4

The temperature estimation system according to Item 1 includes: a measurement related information acquisition unit, acquiring measurement related information relating to the measurement target and a situation of measuring the temperature of the measurement target.

### Item 5

In the temperature estimation system according to Item 4, the estimation model includes multiple estimation models, and the estimation unit selects an estimation model for estimating the temperature of the measurement target from the estimation models in response to the measurement related information.

### Item 6

In the temperature estimation system according to Item 1, the contact measurement data includes multiple contact measurement values, and the temperature estimation system includes: a notification unit, notifying that a quantity of the contact measurement values acquired from or after a rise time point of the contact measurement data has exceeded a predetermined reference value.

### Item 7

In the temperature estimation system according to any one of Items 1 to 6, the contact measurement data includes multiple contact measurement values, the contactless measurement data includes multiple contactless measurement values, and the estimation unit inputs at least one of the contactless measurement values and two or more contact measurement values among the contact measurement values into the estimation model to estimate the temperature of the measurement target.

### Item 8

In the temperature estimation system according to any one Items 1 to 6, the estimation unit inputs an estimated parameter calculated based on the contactless measurement data and the contact measurement data to the estimation model to estimate the temperature of the measurement target.

### Item 9

In the temperature estimation system according to any one Items 1 to 6, the estimation model is a model generated based on a statistical estimation method.

### Item 10

In the temperature estimation system according to Item 9, the statistical estimation method is Bayesian estimation, the estimation model has a posterior probability distribution generated in advance based on the Bayesian estimation, the posterior probability distribution is generated by using multiple contactless measurement values and multiple contact measurement values, and an estimated value having a highest probability in the posterior probability distribution is set as an estimated value of the temperature of the measurement target.

### Item 11

The temperature estimation system according to any one of Items 1 to 6 includes: a display unit, displaying the temperature of the measurement target estimated by the estimation unit.

### Item 12

In the temperature estimation system according to Item 11, the display unit displays a transition of the temperature of the measurement target estimated by the estimation unit.

### Item 13

In the temperature estimation system according to Item 11, the estimation unit determines whether the temperature of the measurement target is able to be estimated based on the contactless measurement data and the contact measurement data, and the display unit displays a measurement error in a case where the estimation unit determines that the temperature of the measurement target is unable to be estimated.

### Item 14

A temperature estimation method includes: a step of estimating a temperature of a measurement target by using a predetermined estimation model based on contactless measurement data and contact measurement data acquired by measuring the temperature of the measurement target; and a step of storing measurement history data including the contactless measurement data and the contact measurement data measured at multiple measurement opportunities.

### Item 15

A program, when executed by a computer, causes the computer to: estimate a temperature of a measurement target by using a predetermined estimation model based on contactless measurement data and contact measurement data acquired by measuring the temperature of the measurement target; and store measurement history data including the contactless measurement data and the contact measurement data measured at multiple measurement opportunities.

### Item 16

A temperature measurement device includes: a contactless type temperature measurement unit, measuring a temperature of a measurement target and acquiring contactless measurement data including multiple contactless measurement values; a contact type temperature measurement unit, measuring the temperature of the measurement target and acquiring contact measurement data including multiple contact measurement values; and a transmission unit, transmitting measurement result information based on the contactless measurement data and the contact measurement data.

### Item 17

In the temperature measurement device according to Item 16, the transmission unit transmits, as the measurement result information, at least one of the contactless measurement values and two or more contact measurement values among the contact measurement values.

### Item 18

In the temperature measurement device according to Item 16, the transmission unit transmits, as the measurement result information, an estimated parameter calculated based on the contactless measurement data and the contact measurement data.

### Item 19

The temperature measurement device according to any one of Items 16 to 18 includes: a measurement related information acquisition unit, acquiring measurement related information relating to the measurement target and a situation of measuring the temperature of the measurement target.

### Item 20

In the temperature measurement device according to Item 19, the transmission unit transmits the measurement result information and the measurement related information.

### Item 21

A temperature measurement method includes: a step in which a contactless type temperature measurement unit of a temperature measurement device measures a temperature of a measurement target and acquires contactless measurement data including multiple contactless measurement values; a step in which a contact type temperature measurement unit of the temperature measurement device measures the temperature of the measurement target and acquires contact measurement data including multiple contact measurement values; and a step in which measurement result information is transmitted based on the contactless measurement data and the contact measurement data.

### Item 22

A program, when executed by a computer, causing the computer to: control a contactless type temperature measurement unit of a temperature measurement device to measure a temperature of a measurement target and acquire contactless measurement data including multiple contactless measurement values; controlling a contact type temperature measurement unit of the temperature measurement device to measure the temperature of the measurement target and acquire contact measurement data including multiple contact measurement values; and transmit measurement result information based on the contactless measurement data and the contact measurement data.

As described above, the invention has been described by using the embodiments, but the technical scope of the invention is not limited to the scope described in the embodiments. It is apparent to those skilled in the art that various changes or improvements can be added to the embodiments. It is apparent from the description of the claims that forms with such changes or improvements added may still fall within in the technical scope of the invention.

It should be noted that the execution order of the respective processes such as operations, procedures, steps, and stages in the devices, systems, programs, and methods indicated in the claims, specification, and drawings can be realized in any order unless specifically indicated as “before” or “prior to”, and unless the output of the previous process is used in the subsequent process. Even if the operation flow in the claims, specification, and drawings is described by using “first,” “next,” etc., for the convenience, this does not mean that it is essential to implement in this order.

What is claimed is:

1. A temperature estimation system, comprising:
an estimation unit, estimating a temperature of a measurement target by using a predetermined estimation model based on contactless measurement data and contact measurement data acquired by measuring the temperature of the measurement target; and
a storage unit, storing measurement history data comprising the contactless measurement data and the contact measurement data measured at a plurality of measurement opportunities.

2. The temperature estimation system as claimed in claim 1, comprising: a model update unit, updating the estimation model based on the measurement history data.

3. The temperature estimation system as claimed in claim 2, wherein, by using the updated estimation model, the estimation unit corrects the temperature of the measurement target estimated based on the contactless measurement data and the contact measurement data measured at past measurement opportunities of the measurement opportunities.

4. The temperature estimation system as claimed in claim 1, comprising: a measurement related information acquisition unit, acquiring measurement related information relating to the measurement target and a situation of measuring the temperature of the measurement target.

5. The temperature estimation system as claimed in claim 4, wherein:
the estimation model comprises a plurality of estimation models, and
the estimation unit selects an estimation model for estimating the temperature of the measurement target from the estimation models in response to the measurement related information.

6. The temperature estimation system as claimed in claim 1, wherein:
the contact measurement data comprises a plurality of contact measurement values, and
the temperature estimation system comprises: a notification unit, notifying that a quantity of the contact measurement values acquired from or after a rise time point of the contact measurement data has exceeded a predetermined reference value.

7. The temperature estimation system as claimed in claim 1, wherein:
the contact measurement data comprises a plurality of contact measurement values,
the contactless measurement data comprises a plurality of contactless measurement values, and
the estimation unit inputs at least one of the contactless measurement values and two or more contact measurement values among the contact measurement values into the estimation model to estimate the temperature of the measurement target.

8. The temperature estimation system according to claim 1, wherein:
the estimation unit inputs an estimated parameter calculated based on the contactless measurement data and the contact measurement data to the estimation model to estimate the temperature of the measurement target.

9. The temperature estimation system as claimed in claim 1, wherein:
the estimation model is a model generated based on a statistical estimation method.

10. The temperature estimation system as claimed in claim 9, wherein:
the statistical estimation method is Bayesian estimation,
the estimation model has a posterior probability distribution generated in advance based on the Bayesian estimation,
the posterior probability distribution is generated by using a plurality of contactless measurement values and a plurality of contact measurement values, and
an estimated value having a highest probability in the posterior probability distribution is set as an estimated value of the temperature of the measurement target.

11. The temperature estimation system as claimed in claim 1, comprising:
a display unit, displaying the temperature of the measurement target estimated by the estimation unit.

12. The temperature estimation system as claimed in claim 11, wherein the display unit displays a transition of the temperature of the measurement target estimated by the estimation unit.

13. The temperature estimation system as claimed in claim 11, wherein:
the estimation unit determines whether the temperature of the measurement target is able to be estimated based on the contactless measurement data and the contact measurement data, and
the display unit displays a measurement error in a case where the estimation unit determines that the temperature of the measurement target is unable to be estimated.

14. A temperature measurement device, comprising:
a contactless type temperature measurement unit, measuring a temperature of a measurement target and acquiring contactless measurement data comprising a plurality of contactless measurement values;
a contact type temperature measurement unit, measuring the temperature of the measurement target and acquiring contact measurement data comprising a plurality of contact measurement values; and
a transmission unit, transmitting measurement result information based on the contactless measurement data and the contact measurement data.

15. The temperature measurement device as claimed in claim 14, wherein the transmission unit transmits, as the measurement result information, at least one of the contactless measurement values and two or more contact measurement values among the contact measurement values.

16. The temperature measurement device as claimed in claim 14, wherein the transmission unit transmits, as the measurement result information, an estimated parameter calculated based on the contactless measurement data and the contact measurement data.

17. The temperature measurement device as claimed in claim 14, comprising:
a measurement related information acquisition unit, acquiring measurement related information relating to the measurement target and a situation of measuring the temperature of the measurement target.

18. The temperature measurement device as claimed in claim 17, wherein the transmission unit transmits the measurement result information and the measurement related information.
